(19) United States
(12) Patent Application Publication
(10) Pub. No.: US 2021/0305597 A1
(43) Pub. Date: Sep. 30, 2021

(54) GAS SAMPLING SYSTEM AND GAS SAMPLING METHOD FOR FUEL CELL, CURRENT DENSITY DISTRIBUTION ESTIMATION METHOD FOR FUEL CELL, AND CALIBRATION METHOD FOR INTERNAL STATE MODEL OF FUEL CELL

(71) Applicant: TSINGHUA UNIVERSITY, Beijing (CN)

(72) Inventors: JIAN-QIU LI, Beijing (CN); QING WANG, Beijing (CN); LIANG-FEI XU, Beijing (CN); CHUAN FANG, Beijing (CN); ZUN-YAN HU, Beijing (CN); HONG-LIANG JIANG, Beijing (CN); MING-GAO OUYANG, Beijing (CN)

(21) Appl. No.: 17/340,094

(22) Filed: Jun. 7, 2021

Related U.S. Application Data
(63) Continuation of application No. PCT/CN2019/128921, filed on Dec. 27, 2019.

(30) Foreign Application Priority Data
Dec. 29, 2018 (CN) 201811641141.6
Dec. 29, 2018 (CN) 201811641176.X
Dec. 29, 2018 (CN) 201811646079.X

(51) Int. Cl. H01M 8/04119; H01M 8/04746; H01M 8/04298; H01M 8/04858

(52) U.S. Cl. CPC H01M 8/04119; H01M 8/04902; H01M 8/04305; H01M 8/04753

(57) ABSTRACT

Disclosed are a gas sampling system and a gas sampling method for a fuel cell, a current density distribution estimation method for the fuel cell, a calibration method and a calibration device for an internal state model for the fuel cell, and a computer equipment. The gas sampling method for a fuel cell includes arranging a plurality of sampling pipelines and a plurality of sampling points, the plurality of sampling points being arranged at a cathode inlet, an anode outlet, an anode inlet, a cathode outlet, and in an anode flow channel, and a cathode flow channel of the fuel cell, the sampling points arranged in the anode flow channel and the cathode flow channel being located in central regions of cross sections of the flow channels, and the sampling pipelines being connected to the plurality of sampling points, respectively, and configured to guide gas inside the fuel cell out.

### CROSS-REFERENCE TO RELATED APPLICATIONS

This application is a continuation application of PCT Patent Application No. PCT/CN2019/128921, entitled “GAS SAMPLING SYSTEM AND GAS SAMPLING METHOD FOR FUEL CELL, CURRENT DENSITY DISTRIBUTION ESTIMATION METHOD FOR FUEL CELL, AND CALIBRATION METHOD FOR INTERNAL STATE MODEL OF FUEL CELL”, filed on Dec. 27, 2019, which claims priority benefits from China Patent Application No. 201811646079.X, filed on Dec. 29, 2018, entitled “GAS SAMPLING SYSTEM AND GAS SAMPLING METHOD FOR FUEL CELL”, China Patent Application No. 201811641176.X, filed on Dec. 29, 2018, entitled “CURRENT DENSITY DISTRIBUTION ESTIMATION METHOD AND DEVICE FOR FUEL CELL, AND COMPUTER STORGE MEDIUM”, and China Patent Application No. 201811641141.6, filed on Dec. 29, 2018, entitled “CALIBRATION METHOD AND DEVICE FOR INTERNAL STATE MODEL OF FUEL CELL, AND COMPUTER EQUIPMENT”. The entireties of these applications are incorporated by reference herein for all purposes.

### TECHNICAL FIELD

The present disclosure relates to the field of fuel cell technology, and in particular to a gas sampling system and a gas sampling method for a fuel cell, a current density distribution estimation method for the fuel cell, and a calibration method for an internal state model of the fuel cell.

### BACKGROUND

A fuel cell is an electrochemical power generation device, whose principle is that an electric potential is produced by an electrochemical reaction between a fuel (for example, hydrogen) and an oxidant (for example, air) by means of a membrane electrode. A proton exchange membrane fuel cell usually uses a polymer membrane as the electrolyte, which can transport protons. During the reaction, the protons are transported from the anode to the cathode through the membrane, and the electrons are transported from the anode to the cathode through a connected external load. The gas concentration inside the fuel cell is of great significance for the performance evaluation of the fuel cell. Therefore, the system and the method for sampling gas inside the fuel cell system become very important.

At present, methods for sampling the gas inside a large individual cell of the fuel cell or inside individual cells of different types of fuel cells are not well-developed. The solutions known to the inventors are only for a small individual cell of a single-channel fuel cell, and achieve sampling by means of a single sampling port. The solutions known to the inventors cannot realize multi-point gas sampling of the fuel cell, and cannot monitor the gas concentration at different locations inside the fuel cell.

### SUMMARY

In order to achieve multi-point gas sampling of the fuel cell, and monitor the gas concentration at different locations inside the fuel cell, a gas sampling system and a gas sampling method for a fuel cell are provided.

A gas sampling method for a fuel cell includes:

arranging a plurality of sampling pipelines and a plurality of sampling points, the plurality of sampling points being arranged at a cathode inlet, an anode outlet, an anode inlet, a cathode outlet, and in an anode flow channel and a cathode flow channel of the fuel cell, the sampling points arranged in the anode flow channel and the cathode flow channel being located in central regions of cross sections of the flow channels, and the sampling pipelines being connected to the plurality of sampling points, respectively, and configured to guide the gas inside the fuel cell out;

introducing reactant gases into the cathode inlet and the anode inlet, respectively, and connecting an electronic load between the anode plate and the cathode plate of the fuel cell; and

obtaining gas samples of the plurality of sampling points guided out by means of the sampling pipelines complete gas sampling of the fuel cell.

A gas sampling system for the fuel cell includes:

an anode plate provided with an anode flow channel supplying a passage for a gas flow,

a membrane electrode arranged on a side of the anode plate, the anode flow channel being disposed on the side of the anode plate,

a cathode plate arranged on a side of the membrane electrode, the side of the membrane electrode being away from the anode plate, and the cathode plate being provided with a cathode flow channel supplying a passage for a gas flow,

a plurality of sampling points arranged in the anode flow channel and the cathode flow channel and located in central regions of cross sections of the flow channels,

a plurality of sampling pipelines connected to the plurality of sampling points, respectively, and configured to guide gas inside the fuel cell out.

In the gas sampling method of the fuel cell provided in the present disclosure, the plurality of sampling points are arranged to obtain the gas samples of different locations in the fuel cell respectively, so as to achieve multi-point gas sampling inside the fuel cell, and monitor gas concentrations at different locations inside the fuel cell in real time. The plurality of sampling points are located in the central regions of the cross sections of the anode flow channel and the cathode flow channel, and the gas flowing through the flow channels may be accurately obtained. By arranging the plurality of sampling points in the flow channels on the anode plate and the cathode plate of the fuel cell, the gas sample at each point may be obtained. The analysis of contents and concentrations of the gas can help to obtain safer and more reliable working conditions for the fuel cell, thereby ensuring working safety and a service life of the fuel cell, and ensuring the utilization rate of the fuel cell.

In order to solve the problems that it is difficult to design the schemes known to the inventors by installing sensors or measuring gaskets inside the fuel cell, and that the cost for the design is high, a current density distribution estimation method and device for a fuel cell, and a computer storage media are provided.

A current density distribution estimation method of a fuel cell includes:

defining a plurality of regions on the cathode plate of the fuel cell, the cathode plate having a cathode flow channel, arranging a plurality of sampling points at intervals along a running direction of the cathode flow channel in each region, and each sampling point being located in a central region of each cross section of the cathode flow channel,

calculating a variation oxygen concentration in each region,

calculating a current value of each region according to a Faraday's law, the current value being equal to a product of the variation of oxygen concentration in each region, a volume flow rate of oxygen and a quadruple Faraday constant, obtaining current values in the plurality of regions, respectively, and

obtaining current densities of the plurality of regions respectively according to a ratio of the current value of each region to an area thereof, and generating a current density distribution diagram of the fuel cell according to the current densities of the plurality of regions and the plurality of regions.

A current density distribution estimation device for a fuel cell includes:

a gas sample acquiring module configured to acquire gas samples information of a plurality of sampling points arranged in a plurality of regions of the cathode plate of the fuel cell at intervals along a running direction of a cathode flow channel,

an oxygen concentration calculating module configured to calculate a variation of oxygen concentration in each region,

a regional current calculating module configured to calculate a current value of each region, and

a current density distribution diagram generating module configured to generate a current density distribution diagram of the plurality of regions in the fuel cell.

The present disclosure relates to the field of fuel cell technology, and in particular to a current density distribution estimation method and device for the fuel cell and a computer storage medium. In the current density distribution estimation method for the fuel cell of the present disclosure, under the conditions that no other sensors or no other sensor gaskets are provided, current densities in different regions are calculated on the basis of the sampled results of the plurality of sampling points, so as to obtain the current density distribution for the individual cell of the fuel cell. The current density distribution estimation method for the fuel cell of the present disclosure can accurately obtain the current density distribution diagram for the fuel cell.

In order to solve the problem that, in the solutions known to the inventors, the state of the fuel cell is considered to be consistent, but the differences between the individual cells of the fuel cell are not taken into account, a calibration method, a calibration device for an internal state model of the fuel cell, and computer equipment are provided.

A calibration method for an internal state model of a fuel cell includes: S01, determining an equivalent model for the fuel cell,

S02, establishing an internal state process equation of the fuel cell by integrating the equivalent model for the fuel cell and working conditions of the fuel cell, and determining a quantity to be calibrated in the internal state process equation of the equivalent model for the fuel cell,

S03, obtaining operational parameters in internal state process equation of the fuel cell are obtained by a multi-point gas sampling method for the fuel cell,

S04, substituting the operational parameters into the internal state process equation of the equivalent model of the fuel cell to obtain one quantity or a set of quantities to be calibrated, and

S05, performing step S03 and step S04 repeatedly to obtain a plurality of values of the quantity or a plurality of groups of values corresponding to the set of quantities to be calibrated, and completing a calibration of the quantities to be calibrated till a variation range of the quantity to be calibrated is within a preset range, or a sum of squared errors corresponding to the set of quantities to be calibrated is within the preset range.

A calibration device for an internal state model of a fuel cell includes:

a fuel cell equivalent model determination unit configured to determine a model applicable to the fuel cell,

a fuel cell internal state process determination unit configured to establish an internal state process equation for the fuel cell and determine a quantity to be calibrated in combination with an equivalent model of the fuel cell and working conditions of the fuel cell,

an operational parameter acquisition unit configured to acquire operational parameters in an internal state process equation of the fuel cell,

an operational parameter calculation unit configured to substitute the operational parameters into the internal state process equation of a single-flow-channel and multi-cavity model to obtain one quantity or one set of quantities to be calibrated, and

a loop determination unit configured to determine whether a plurality of values of the quantity or a plurality of groups of values corresponding to the set of quantities to be calibrated need to be further acquired, if an average of the values of the quantity to be calibrated or a sum of squared errors corresponding to the values of the set of quantities to be calibrated is less than a threshold, then the plurality of values of the quantity to be calibrated or the plurality of groups of values corresponding to the set of quantities to be calibrated being not further acquired.

The present disclosure provides the calibration method and the calibration device for the internal state model of the fuel cell and the computer equipment. In the present disclosure, in view of the large-area fuel cell, the internal state model of the fuel cell is established, and then the quantity to be calibrated in the established model is calibrated. During the calibration of the quantity to be calibrated, a set of experiments of steady-state gas sampling are performed, and the calibration of the quantity to be calibrated is completed by means of measuring and analyzing the internal state of the fuel cell. The calibrated model of the fuel cell has higher accuracy and has a certain significance and value for studying the unevenness of a single channel in the individual cell with large area and a plurality of flow channels, and for studying the difference between different flow channels of the fuel cell.

### BRIEF DESCRIPTION OF THE DRAWINGS

FIG. 1 is a flow chart of a gas sampling method for a fuel cell, according to an embodiment of the present disclosure.

FIG. 2 is a schematic structural diagram illustrating a gas sampling system for a fuel cell, according to an embodiment of the present disclosure.

FIG. 3 is a schematic diagram illustrating distribution positions of sampling points in parallel flow channels on an anode plate, according to an embodiment of the present disclosure.

FIG. 4 is a schematic diagram illustrating the distribution positions of the sampling points in the parallel flow channels on the anode plate, according to another embodiment of the present disclosure.

FIG. 5 is a schematic diagram illustrating the distribution positions of the sampling points in the parallel flow channels on the anode plate, according to yet another embodiment of the present disclosure.

FIG. 6 is a schematic diagram illustrating distribution positions of sampling points in parallel flow channels on a cathode plate, according to an embodiment of the present disclosure.

FIG. 7 is a schematic diagram illustrating the distribution positions of the sampling points in the parallel flow channels on the cathode plate, according to another embodiment of the present disclosure.

FIG. 8 is a schematic diagram illustrating the distribution positions of the sampling points in the parallel flow channels on the cathode plate, according to yet another embodiment of the present disclosure.

FIG. 9 is a schematic diagram illustrating distribution positions of sampling points in snake-like flow channels on an anode plate, according to an embodiment of the present disclosure.

FIG. 10 is a schematic diagram illustrating the distribution positions of the sampling points in the snake-like flow channels on the anode plate, according to another embodiment of the present disclosure.

FIG. 11 is a schematic diagram illustrating the distribution positions of the sampling points in the snake-like flow channels on the anode plate, according to yet another embodiment of the present disclosure.

FIG. 12 is a schematic diagram illustrating distribution positions of sampling points in snake-like flow channels on a cathode plate, according to an embodiment of the present disclosure.

FIG. 13 is a schematic diagram illustrating the distribution positions of the sampling points in the snake-like flow channels on the cathode plate, according to another embodiment of the present disclosure.

FIG. 14 is a schematic diagram illustrating the distribution positions of the sampling points in the snake-like flow channels on the cathode plate, according to yet another embodiment of the present disclosure.

FIG. 15 is a schematic diagram illustrating distribution positions of sampling points in interdigitated flow channels on an anode plate, according to an embodiment of the present disclosure.

FIG. 16 is a schematic diagram illustrating the distribution positions of the sampling points in the interdigitated flow channels on the anode plate, according to another embodiment of the present disclosure.

FIG. 17 is a schematic diagram illustrating the distribution positions of the sampling points in the interdigitated flow channels on the anode plate, according to yet another embodiment of the present disclosure.

FIG. 18 is a schematic diagram illustrating distribution positions of sampling points in interdigitated flow channels on a cathode plate, according to an embodiment of the present disclosure.

FIG. 19 is a schematic diagram illustrating the distribution positions of the sampling points in the interdigitated flow channels on the cathode plate, according to another embodiment of the present disclosure.

FIG. 20 is a schematic diagram illustrating the distribution positions of the sampling points in the interdigitated flow channels on the cathode plate, according to yet another embodiment of the present disclosure.

FIG. 21 is a schematic flow chart of a current density distribution estimation method for a fuel cell, according to an embodiment of the present disclosure.

FIG. 22 is a schematic structural diagram illustrating the gas sampling system for the fuel cell, according to another embodiment of the present disclosure.

FIG. 23 is a schematic flow chart of the current density distribution estimation method for the fuel cell, according to a specific embodiment of the present disclosure.

FIG. 24 is a diagram showing current density distributions in different regions of a cathode flow channel, according to an embodiment of the present disclosure.

FIG. 25 is a schematic structural block diagram illustrating a current density distribution estimation device for a fuel cell, according to an embodiment of the present disclosure.

FIG. 26 is a flow chart of a calibration method for an internal state model of a fuel cell, according to an embodiment of the present disclosure.

FIG. 27 is a flow chart of the calibration method for the internal state model of the fuel cell, according to another embodiment of the present disclosure.

FIG. 28 is a schematic diagram illustrating a two-cavity model of cathode inlet and outlet, according to an embodiment of the present disclosure.

FIG. 29 is a flow chart of the calibration method for the internal state model of the fuel cell, according to yet another embodiment of the present disclosure.

FIG. 30 is a schematic diagram illustrating a model of difference between flow channels in an individual cell of the fuel cell, according to an embodiment of the present disclosure.

FIG. 31 is a schematic diagram illustrating verification results of a calibrated flow resistance coefficient in a single-flow-channel and multi-cavity model, according to an embodiment of the present disclosure.

FIG. 32 is a schematic diagram illustrating verification results of a calibrated linear parameter and a reference quantity in the model of difference between flow channels, according to an embodiment of the present disclosure.

### DETAILED DESCRIPTION OF THE EMBODIMENTS

In order to make the present disclosure better understood, the present disclosure will be described in detail with reference to relevant drawings. The drawings show preferred embodiments of the present disclosure. However, the present disclosure may be implemented in many different forms and is not limited to the embodiments described herein. On the contrary, the purpose of providing these embodiments is to make the present disclosure to be more thoroughly and comprehensively understood.

In a first embodiment of the present disclosure, it is necessary to provide a gas sampling system and a gas sampling method for a fuel cell to solve a problem that solutions known to the inventors cannot achieve multi-point gas sampling inside the fuel cell and cannot monitor gas concentration at different locations inside the fuel cell.

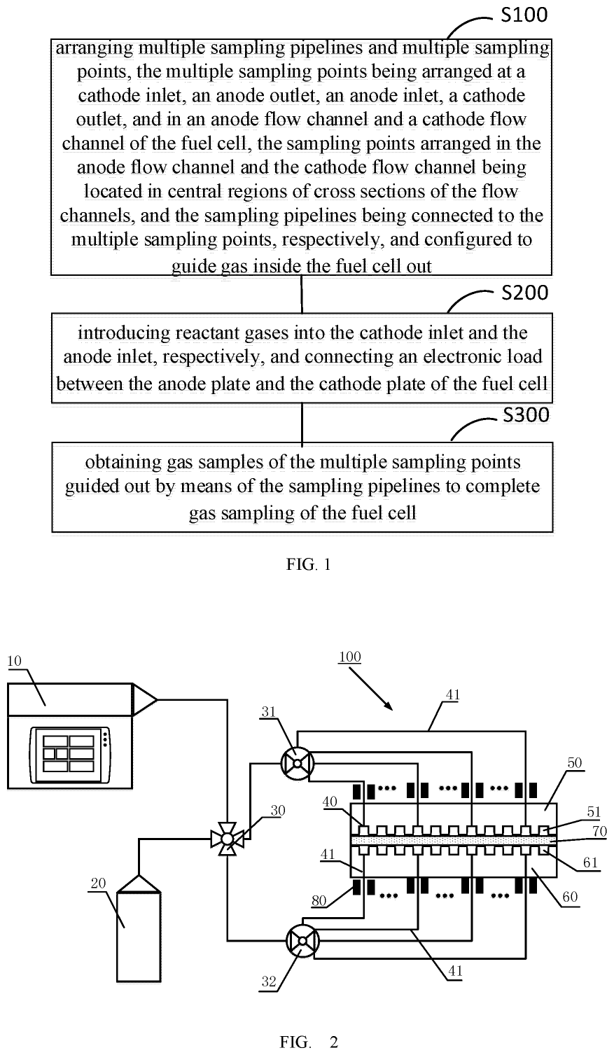

With reference to FIG. 1 to FIG. 3, the present disclosure provides a gas sampling method for a fuel cell, which includes at least the following steps:

At step S100, a plurality of sampling pipelines 41 and a plurality of sampling points 40 are arranged. The plurality of sampling points 40 are arranged at a cathode inlet 1, an anode outlet 3, an anode inlet 4, a cathode outlet 6, and in an anode flow channel 51 and a cathode flow channel 61 of the fuel cell. The sampling points 40 arranged in the anode flow channel 51 and the cathode flow channel 61 are located in central regions of cross sections of the flow channels. The sampling pipelines 41 are connected to the plurality of sampling points 40, respectively, and configured to guide the gas inside the fuel cell out.

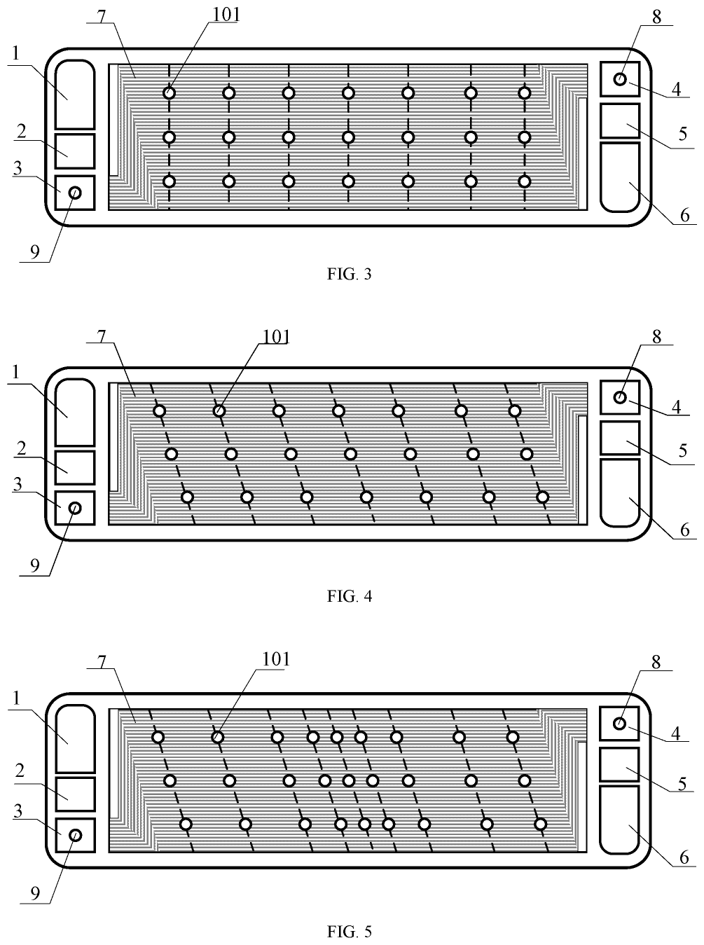

In this step, arranging the sampling points in the central regions of the cross sections of the flow channels can be understood that the sampling pipes 41 pass through the flow channel plates provided with the anode flow channel 51 and the cathode flow channel 61, and an end point of each sampling pipe 41, which extends into the flow channel, may directly contact the gas inside the fuel cell to be one of the sampling points 40. With reference to FIG. 3, in addition to the sampling points arranged at the cathode inlet 1, the anode outlet 3, the anode inlet 4, and the cathode outlet 6 of the fuel cell, the plurality of sampling points 40 also include those arranged in the flow channel plate provided with the anode flow channel 51 and the cathode flow channel 61. By means of the sampling points 40 arranged in the flow channel plates provided with the anode flow channel 51 and the cathode flow channel 61, gas samples may be obtained at different positions inside the fuel cell.

At step S200, reactant gases are introduced into the cathode inlet 1 and the anode inlet 4, respectively, and an electronic load is connected between the anode plate 50 and the cathode plate 60 of the fuel cell.

In this step, a cathode standard gas and an anode standard gas are introduced into the cathode inlet 1 and the anode inlet 4, respectively. After the gases are introduced, a certain electronic load is connected between the cathode plate 60 and the anode plate 50. For example, the electronic load may be a set current of 0 A/cm² to 2 A/cm² output by an individual cell of the fuel cell.

At step S300, the gas samples of the plurality of sampling points 40 guided out by means of the sampling pipelines 41 are obtained to complete gas sampling of the fuel cell.

In this step, the sampling device 10 may be used to obtain the gas samples of the plurality of sampling points 40, which are guided out by means of the sampling pipelines 41. The sampling device 10 may analyze the gas samples and obtain the analysis results to guide the use of the fuel cell.

In this embodiment, the plurality of sampling points 40 are arranged to obtain the gas samples of different locations in the fuel cell respectively, so as to achieve multi-point gas sampling inside the fuel cell, and monitor gas concentrations at different locations inside the fuel cell in real time. The plurality of sampling points 40 are located in the central regions of the cross sections of the anode flow channel 51 and the cathode flow channel 61, and the gas flowing through the flow channels may be accurately obtained. By arranging the plurality of sampling points 40 in the flow channels on the anode plate 50 and the cathode plate 60 of the fuel cell, the gas sample at each point may be obtained. The analysis of contents and concentrations of the gas can help to obtain safer and more reliable working conditions for the fuel cell, thereby ensuring working safety and a service life of the fuel cell, and ensuring the utilization rate of the fuel cell.

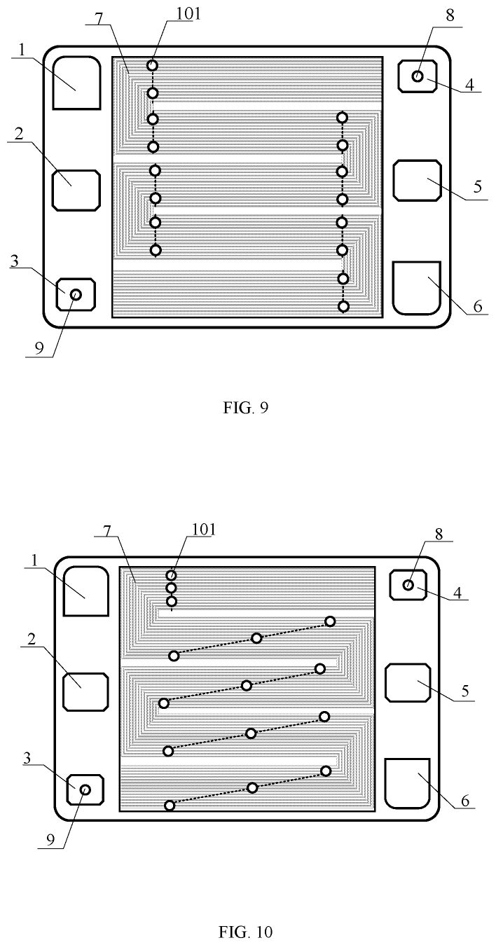

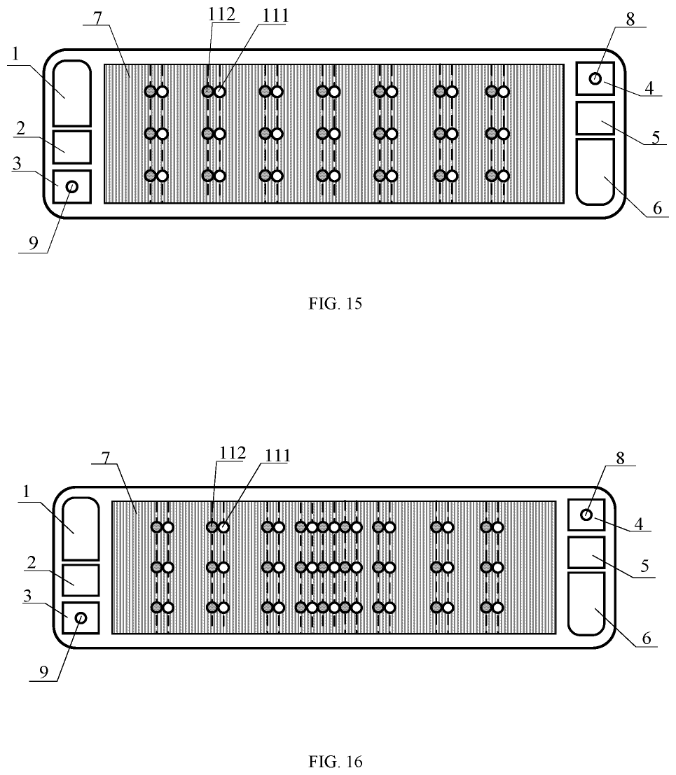

FIGS. 3 to 8 of the present disclosure show schematic diagrams illustrating distribution positions of sampling points in bipolar plates having parallel flow channels. FIGS. 9 to 14 of the present disclosure show schematic diagrams illustrating the distribution positions of the sampling points in the bipolar plates having snake-like flow channels. FIGS. 15 to 20 of the present disclosure show schematic diagrams illustrating the distribution positions of sampling points in the bipolar plates having interdigitated flow channels. The plurality of sampling points 40 include an anode inlet sampling point 8, an anode outlet sampling point 9, other sampling points 101 in the flow channels, other sampling points 111 in the inlet flow channel, and other sampling points 112 in the outlet flow channel.

In an embodiment, the step of arranging the plurality of sampling points 40 specifically includes following steps.

At step S110, the plurality of sampling points 40 are arranged in the anode flow channels 51 of the fuel cell at identical intervals along running directions of the anode flow channels. At step S120, the plurality of sampling points 40 are arranged in the cathode flow channels 61 of the fuel cell at identical intervals along running directions of the cathode flow channels. In this embodiment, the plurality of sampling points 40 are respectively arranged in the flow channels each spaced at intervals of one or more anode flow channels 51, and arranged in the flow channels each spaced at intervals of one or more of the cathode flow channels 61, thus enabling the number of the sampling points 40 to be distributed reasonably. In this embodiment, for the method for arranging the plurality of sampling points 40, please refer to the arranging method above.

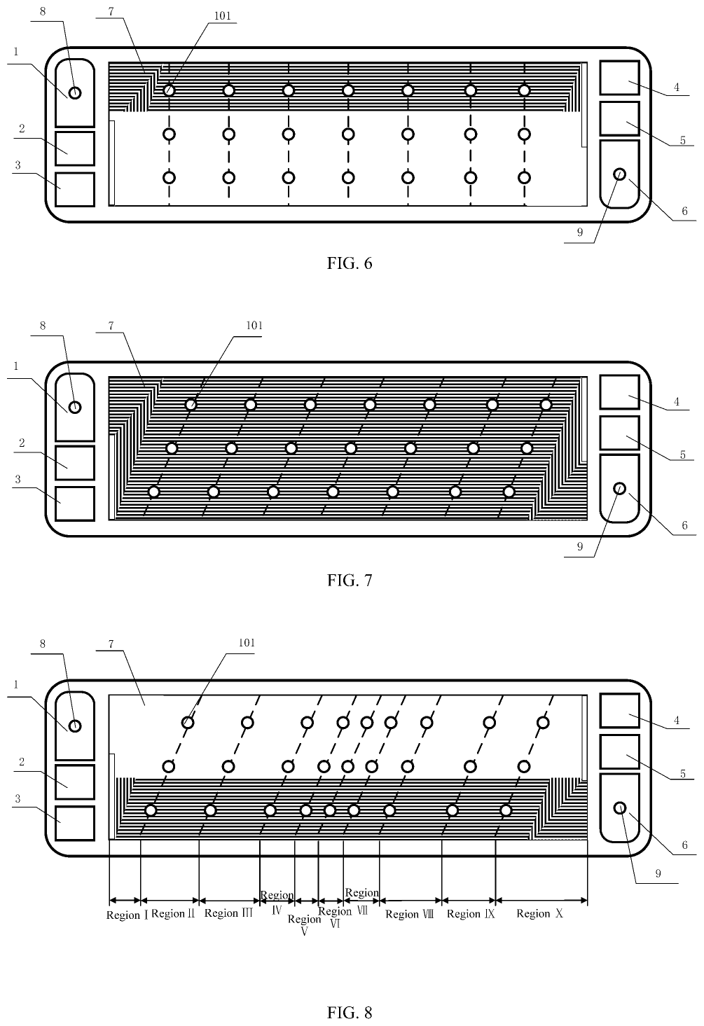

In this embodiment, for the arrangement of the plurality of sampling points 40, please refer to the following drawings. As shown in FIGS. 3, 4, 6 and 7, in the fuel cell provided with parallel flow channels, the plurality of sampling points 40 are arranged at identical intervals along the running direction of the corresponding flow channel. As shown in FIG. 3 and FIG. 6, the sampling points 40 are arranged at identical intervals without considering a curved structure of each flow channel. As shown in FIG. 4 and FIG. 7, the sampling points 40 are arranged at identical intervals considering the curved structure of each flow channel. In this embodiment, the plurality of sampling points 40 arranged at identical intervals along the running direction of the corresponding flow channel in the fuel cell plate can realize the gas sampling inside the fuel cell as a whole, and the sampled data are more comprehensive and more accurate for guiding a selection of operating conditions of the fuel cell.

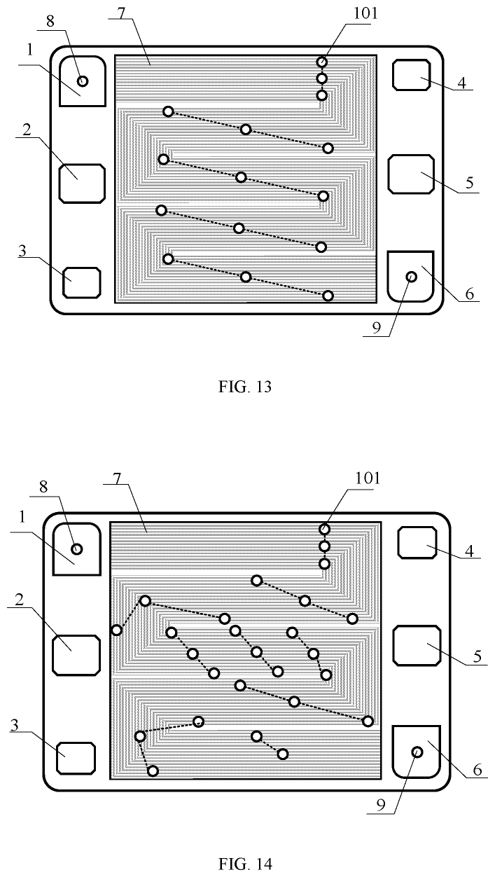

As shown in FIG. 9, FIG. 10, FIG. 12, and FIG. 13, in the fuel cell provided with snake-like flow channels, the plurality of sampling points 40 are arranged at identical intervals along the running direction of the corresponding flow channel. As shown in FIG. 9 and FIG. 12, the sampling points 40 are arranged at identical intervals without considering the curved structure of each flow channel. As shown in FIG. 10 and FIG. 13, the sampling points 40 are arranged at identical intervals considering the curved structure of each flow channel.

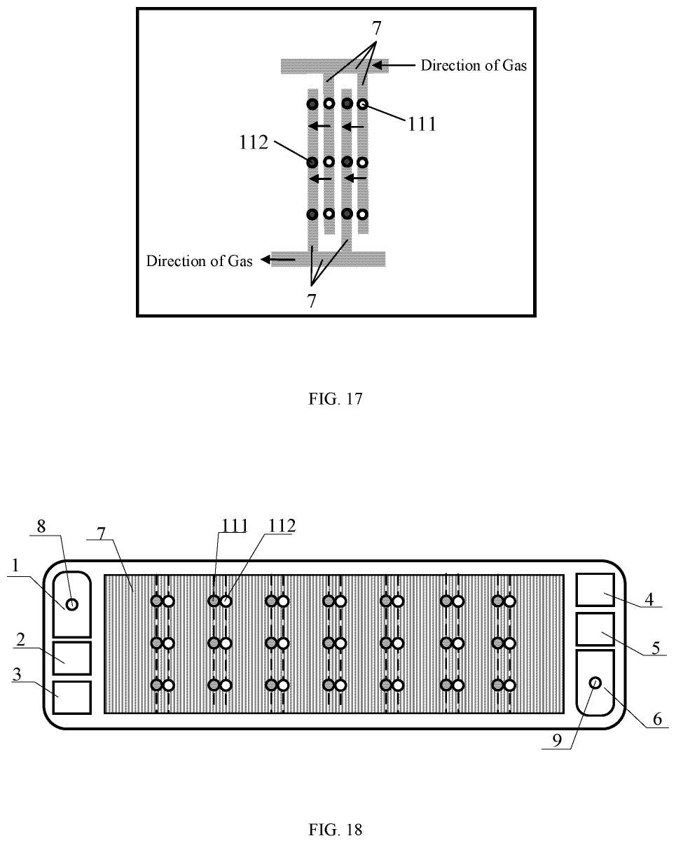

As shown in FIG. 15 and FIG. 18, in the fuel cell provided with interdigitated flow channels, the plurality of sampling points 40 are arranged at identical intervals along the running direction of the corresponding flow channel. FIG. 17 and FIG. 20 show the distribution of the sampling points and the gas diffusion flow directions inside the interdigitated flow channels in the cathode plate and inside the interdigitated flow channels in the anode plate, respectively.

In this embodiment, the plurality of sampling points 40 arranged at identical intervals along the running direction of the corresponding flow channel in the fuel cell plate can realize the gas sampling inside the fuel cell as a whole, and the sampled data are more comprehensive and more accurate for guiding a selection of operating conditions of the fuel cell.

In an embodiment, the fuel cell includes at least three anode flow channels 51 and at least three cathode flow channels 61. In this embodiment, the step of arranging the plurality of sampling points 40 specifically further includes: arranging the plurality of sampling points 40 inside the anode flow channels 51 spaced at intervals of one or more anode flow channels, and arranging the plurality of sampling points 40 inside the cathode flow channels 61 spaced at intervals of one or more cathode flow channels.

The method proposed in this embodiment can reasonably allocate the number of sampling points 40. For example, the fuel cell is provided with three anode flow channels 51, the sampling points 40 may be arranged inside the first anode flow channel 51 and the third anode flow channel 51 at intervals, and the intervals may be identical or different. The specific arranging method may be designed according to actual requirements. In addition, considering the density of the sampling points 40, the sampling points 40 may also be arranged at intervals of two flow channels, three flow channels, or four flow channels. For example, the fuel cell is provided with nine cathode flow channels 61, and a plurality of sampling points 40 are arranged inside the first cathode flow channel 61 at identical or different intervals. No sampling points are provided inside the second cathode flow channel 61 and the third cathode flow channel 61. A plurality of sampling points 40 are arranged inside the fourth cathode flow channel 61 at identical or different intervals. No sampling points are provided inside the fifth cathode flow channel 61 and the sixth cathode flow channel 61. A plurality of the sampling points 40 are arranged in the seventh cathode flow channel 61 at identical or different intervals. No sampling points are arranged inside the eighth cathode flow channel 61 and the ninth cathode flow channel 61. The arranging method in this embodiment is not further limited herein.

In an embodiment, the steps of arranging the plurality of sampling points 40 are specifically as follows.

A plurality of regions are divided along the running directions of the anode flow channels 51 inside the fuel cell, and the plurality of sampling points 40 are arranged at a boundary of each region. The distribution densities of the sampling points 40 in different regions are not all identical. A plurality of regions are divided along the running directions of the cathode flow channels 61 inside the fuel cell, and the distribution densities of the sampling points 40 in different regions are not all identical.

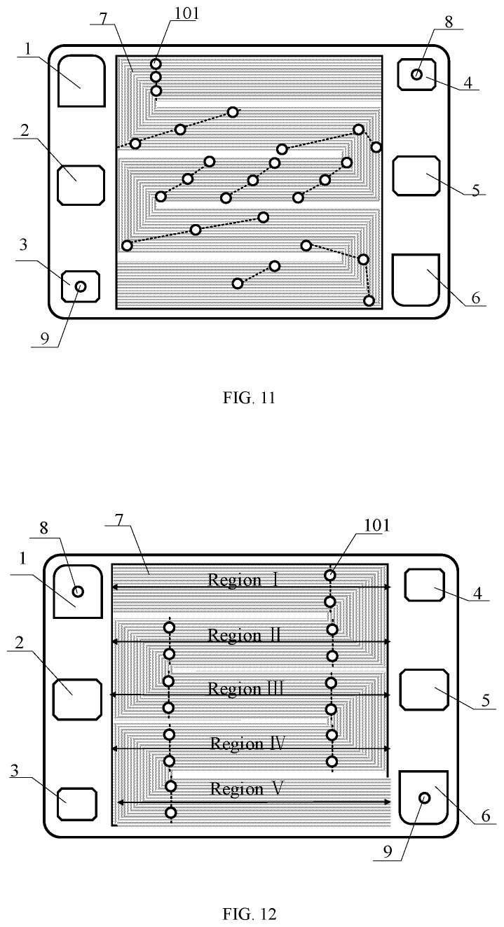

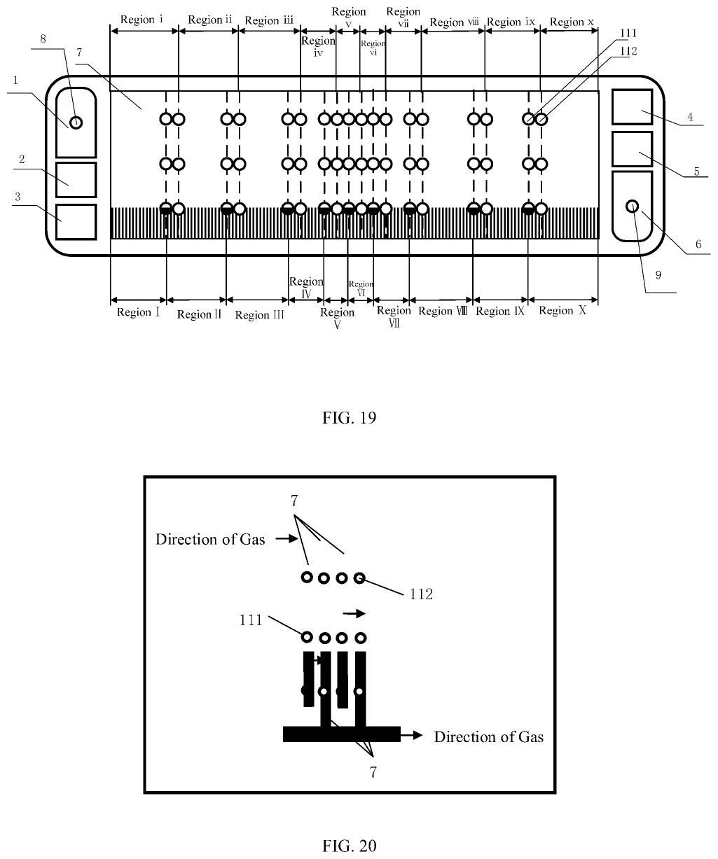

The arranging method of the sampling points 40 provided in this embodiment may be designed with reference to the manners illustrated in FIG. 5, FIG. 8, FIG. 11, FIG. 14, FIG. 16, and FIG. 19. FIG. 5, FIG. 8, FIG. 11, FIG. 14, FIG. 16, and FIG. 19 show the sampling points 40 all arranged at different intervals. For the details, FIG. 8 and FIG. 19 each show a region I, a region II, a region III, a region IV, a region V, a region VI, a region VII, a region VIII, a region IX, and a region X. FIG. 12 shows the region I, the region II, the region III, the region IV, and the region V. The sampling points 40 are arranged at partial locations where the boundary of each region and the flow channels intersect. FIG. 8 shows a schematic diagram of distribution positions of the sampling points in the parallel flow channels in the cathode plate. FIG. 12 shows a schematic diagram of distribution positions of sampling points in the snake-like flow channels in the cathode plate. FIG. 19 shows a schematic diagram of the distribution positions of the sampling points in the interdigitated flow channels in the cathode plate.

In this embodiment of the arranging method of the sampling points 40, the division of regions may be determined according to empirical values of the gas flow in flow channels of the fuel cell, and areas of the divided regions may be identical or different. The gas concentration in the fuel cell may be considered to gradually decrease along the running direction of the flow channel. That the distribution densities of the sampling points 40 in different regions are not all identical means that the numbers of the sampling points 40 arranged at the boundaries of different regions may be identical or different. The distribution densities of the sampling points 40 are not all identical, and the contents of sampled gas inside the fuel cell are also different.

In an embodiment, before the step of introducing the reactant gases into the cathode inlet 1 and the anode inlet 4 respectively, and connecting the electronic load between the anode plate 50 and the cathode plate 60 of the fuel cell, the gas sampling method further includes: introducing an inert gas into the sampling pipeline 41 to sweep the plurality of sampling points 40 and the sampling pipeline 41.

In this embodiment, sweeping the gas sampling system 100 for the fuel cell can make the sampled result of each sampling point 40 more accurate, and avoid an existence of some residual substances in the sampling pipeline 41. Specifically, in an embodiment, before sampling and analyzing the gas, the working conditions of the fuel cell are set so that the sampling and analyzing meet sampling requirements. As shown in FIG. 2, the four-way valve 30 and the gas cylinder 20 communicate. Open the outlet of the gas cylinder 20 (the compressed gas therein is helium), and close a sampling port of the sampling device 10. All other inlets and outlets inside the sampling system 100 are opened, and the entire sampling pipelines 41 are swept with helium, and the temperature and the flow rate of the coolant are set at the same time. After a sweeping process is completed, the outlet of the helium cylinder 20 is closed.

In an embodiment, the gas sampling method for the fuel cell specifically includes following preliminary preparations: supplying air and hydrogen to the fuel cell, setting dew point temperature for humidifying the cathode and the air dry bulb temperature, gradually increasing the air flow rate and the hydrogen flow rate, and increasing the current load, till the working conditions of the fuel cell reach the preset values, and the fuel cell stably operating for an hour. The working conditions of the fuel cell may include: a fuel cell working current of 120 A, a cathode air flow rate of 12 L·min-1, an air intake dew point temperature of 43° C., an anode hydrogen flow rate of 0.9 L·min-1, not humidified intake air, cooling water, and cooling water inlet temperature of 60° C.

Open the sampling port of the sampling device 10, open the outlet of the gas cylinder 20, and sweep the pipeline with helium. After the sampled results of the sampling device 10 remain stable for a period of time, close the inlet of the four-way valve 30, which communicates with the gas cylinder 20. At this time, the step of sweeping the sampling pipelines 41 is completed.

At step (1): all inlets and outlets of a second N-way valve 32 are closed, other ports of a first N-way valve 31 (disposed at the anode) are closed, except that an outlet of the first N-way valve 31, and an inlet of the first N-way valve 31, which communicates with the first sampling point, are opened, to sample the gas at the first sampling point.

At step (2): after gas at the first sampling point is sampled for a period of time, the inlet of the first N-way valve 31 is closed, the outlet of the gas cylinder 20 is opened, and the inlet of the four-way valve 30, which communicates with the gas cylinder 20, is opened; the pipeline is swept with helium for a period of time; the outlet of the gas cylinder 20 is closed, and the inlet of the four-way valve 30, which communicates with the helium cylinder 20, is closed; and after a sampling at the first sampling point is completed, the sampling pipeline 41 is swept.

At step (3): the first N-way valve 31 and an inlet of the second sampling point are opened, gas at the second sampling point is sampled. After the gas sampling at the second sampling point is completed, the sampling pipeline 41 is swept. Step (1) to step (3) are performed repeatedly, and after the sampling pipe 41 is swept each time, switch to a next sampling point, till gas sampling for all sampling points 40 of the anode plate 50 or the cathode plate 60 are completed. When the sampled results are subsequently used, reliable sampled results can be selected to guide the application of the fuel cell.

In the foregoing embodiments, the sampling device 10 may be a mass spectrograph. The mass spectrograph achieves gas sampling for the plurality of sampling points 40 by means of sampling gas at the second sampling point after finishing sampling gas at the first sampling point. The mass spectrograph analyzes the gas sample of each sampling point 40 separately. If the sampling device 10 is changed, sampling and analysis for a plurality of points may also be realized simultaneously. That is, gas at the first sampling point, the second sampling point, and the third sampling point (a plurality of sampling points) may be sampled at the same time. At this time, the first N-way valve 31 and the second N-way valve 32 may be omitted.

In an embodiment, before the gas samples of the plurality of sampling points 40 are guided out by means of the sampling pipelines 41 to complete gas sampling of the fuel cell, the gas sampling method further includes following steps.

A sampling device 10 is provided. In an embodiment, the sampling device 10 may be the mass spectrograph. The sampling device 10 is calibrated by using the anode standard gas and the cathode standard gas. The sampling device 10 is calibrated, thereby ensuring the accuracy of the sampled results.

The step of calibrating the sampling device 10 specifically includes: introducing the anode standard gas into the sampling pipelines 41, and analyzing, by the sampling device 10, the gas samples to obtain the first-type sampled result; introducing the cathode standard gas into the sampling pipelines 41, and analyzing, by the sampling device 10, the gas samples to obtain the second-type sampled result.

Repeat the above steps to obtain a plurality of first-type sampled results and a plurality of second-type sampled results. The plurality of first-type sampled results and the plurality of second-type sampled results of are analyzed to obtain a sampling correction coefficient of the sampling device 10 through calculation, thus completing the calibration of the sampling device 10.

Referring to FIG. 2, the step of calibrating the sampling device 10 may include the following steps. Step 1 includes: opening the inlet of the four-way valve 30, which communicates with the outlet of the helium cylinder 20, opening the outlet of the helium cylinder 20, opening other three ports of the four-way valve 30, sweeping capillary tubes, the anode flow channels 51, the cathode flow channels 61, and the sampling pipelines (each of which is a gas passing pipeline connecting the capillary tube and the sampling device 10) with helium, till no other residual gas remains in the flow channels and the pipelines.

Step 2 includes: closing the outlet of the helium cylinder 20, closing two ports of the four-way valve 30, which communicate the anode and cathode sampling pipelines respectively, switching the inlet of the four-way valve 30 from communicating with the outlet of the helium cylinder 20, to communicating with the outlet of the anode standard gas cylinder, and introducing the anode standard gas to the sampling device 10. After sampling for a period of time, the sampling device 10 analyzes the sampled gas.

Step 3 includes: closing the outlet of the anode standard gas cylinder, switching the inlet of the four-way valve from communicating with the outlet of the anode standard gas cylinder, to communicating with the outlet of the cathode standard gas cylinder, and introducing the cathode standard gas into the sampling device. After sampling for a period of time, the sampling device 10 analyzes the sampled gas inside the cathode.

Step 4 includes: closing the outlet of the cathode standard gas cylinder, switching the inlet of the four-way valve from communicating with the outlet of the cathode standard gas cylinder, to communicating with the outlet of the helium cylinder, and introducing the anode standard gas into the sampling device. After sampling for a period of time, the sampling device 10 analyzes the sampled gas inside the anode. The pipeline is swept with helium for a period of time.

Step 2 to step 4 are performed repeatedly for twice to three times, to obtain a plurality of comprehensive results, and the correction coefficient of the sampling device is obtained by means of analysis, so as to complete the calibration of the sampling device 10.

With continuing reference to FIG. 2, in an embodiment of the present disclosure, a gas sampling system 100 for a fuel cell is provided, and includes: an anode plate 50, a membrane electrode 70, a cathode plate 60, a plurality of sampling points 40, and a plurality of sampling pipelines 41.

The anode plate 50 is provided with an anode flow channel 51 supplying a passage for gas flow. The membrane electrode 70 is arranged on a side of the anode plate 50, where the anode flow channel 51 is disposed. The cathode plate 60 is arranged on a side of the membrane electrode 70, and the side of the membrane electrode 70 is away from the anode plate 50. The cathode plate 60 has a cathode flow channel 61 providing a passage for gas flow. The anode flow channel 51 and the cathode flow channel 60 are not completely enclosed, and each flow channel is similar to a groove, in which gas flows.

The membrane electrode 70 includes a proton exchange membrane for realizing the exchange or recombination of protons in the proton exchange membrane. The membrane electrode 70 further includes an anode gas diffusion layer and an anode catalyst layer, which are arranged on a first side of the proton exchange membrane. The membrane electrode 70 further includes a cathode catalyst layer and a cathode gas diffusion layer, which are arranged on a second side of the proton exchange membrane.

The plurality of sampling points 40 are arranged in the anode flow channel 51 and the cathode flow channel 61 and located in the central regions of cross sections of the flow channels. The sampling pipelines 41 are connected to the plurality of sampling points 40, respectively, and are configured to guide the gas inside the fuel cell out. The sampling pipeline 41 is mainly a pipeline drawn from a capillary tube inserted into the flow channel from outside the electrode plate. The sampling pipeline 41 may be a stainless steel capillary tube.

In the proton exchange membrane fuel cell, hydrogen and oxygen undergo an electrochemical reaction to produce water and output electrical energy as well. The basic individual cell structure of the fuel cell may include the anode plate 50, the cathode plate 60, and the membrane electrode 70. The anode flow channel 51 is provided on the anode plate 50. The cathode flow channel 61 is provided on the cathode plate 60. The membrane electrode 70 includes the proton exchange membrane, the catalytic layer and the diffusion layer. The proton exchange membrane is a polymer membrane capable of conducting protons. The catalyst layer is a carbon carrier, to which catalytic platinum adheres. The diffusion layer is mainly made of carbon and polytetrafluoroethylene. The proton exchange membrane, the catalytic layer and the diffusion layer constitute the membrane electrode, which provides a place for the reaction between the hydrogen and the oxygen, and performs functions of conducting electricity and heat. The bipolar plates (including the anode plate 50 and the cathode plate 60) generally include carbon plates or metal plates, and flow channels allowing the gas to flow are engraved on the bipolar plates.

In an embodiment, the anode flow channel 51 has a plurality of first-type regions along the running direction thereof. The cathode flow channel 61 has a plurality of second-type regions along the running direction thereof. The plurality of sampling points 40 are respectively disposed in the flow channel where the boundary of each first-type region is located and in the flow channel where the boundary of each second-type region is located, and the distribution densities of the sampling points 40 in different regions are not all identical. Specifically, for the arranging manners of the plurality of sampling points 40, please refer to FIG. 8, FIG. 12 and FIG. 19.

In this embodiment, the areas of the plurality of first-type regions may be equal or unequal. The areas of the plurality of the second-type regions may be equal or unequal. In this embodiment, the areas of the divided regions are not equal, and the densities of the sampling points 40 are not exactly the same, so that gas in different regions can be sampled and detected in different degrees.

In an embodiment, the gas sampling system 100 for the fuel cell further includes a heating cable 80. The heating cable 80 is arranged around an outer side wall of the sampling pipe 41. In an embodiment, the heating cable 80 may ensure that the sampling pipe 41 is maintained at a temperature of 120° C.

In an embodiment, the gas sampling system 100 for the fuel cell further includes a housing. The housing is shown in FIG. 2 but not labeled. The housing is configured to provide a receiving cavity. In an embodiment, the receiving cavity may be defined by an existing cell housing or a cell pack housing, and realizes a function of fixing in an entire sampling process.

In an embodiment, the gas sampling system 100 for the fuel cell further includes: a four-way valve 30. As shown in FIG. 2, the four-way valve 30 is configured to switch between the sweeping pipeline and the sampling pipeline.

In an embodiment, the gas sampling system 100 for the fuel cell further includes a plurality of N-way valves. Specifically, as shown in FIG. 2, the plurality of N-way valves may be the first N-way valve 31 and the second N-way valve 32. In this embodiment, the plurality of N-way valves are configured to realize the communication of different pipelines. When the pipeline needs to be changed, different N-way valves may be arranged at different positions.

In an embodiment, in order to prevent the water vapor in the sampled gas from condensing into liquid water and blocking the pipeline, thus increasing the sampling time and affecting the sampled results, all the sampling pipes 41 in the gas sampling system 100 for the fuel cell are wound with the heating cable 80, so as to ensure that the sampling pipes 41 are maintained at a temperature of 120° C.

In an embodiment, in order to avoid the influence of gas in the non-designated flow channel during sampling, in the gas sampling system 100 for the fuel cell, a contacting surface between an end surface of the sampling pipe 41 and a sampling port of the flow channel is compressed and sealed by an O-shaped sealing ring.

In the first embodiment of the current fuel cell, measured data of distributed parameters may verify reliability of the simulation results of the model, mover, may represent the states of different locations during the operation of the fuel cell, and reflect local characteristics of the fuel cell. The current density inside the fuel cell is one of the key parameters of the fuel cell.

In the schemes known to the inventors, the current distribution of the proton exchange membrane fuel cell is measured by using the sub-cell method. In the schemes known to the inventors, the influences of conditions such as a gas pressure, a gas flow, a cell temperature, and different discharge current densities on the current distribution of the fuel cell are separately investigated. In the schemes known to the inventors, sensors or measuring gaskets need to be installed inside the fuel cell to obtain the current densities of different regions of the fuel cell, thereby obtaining the current density distribution of the individual cell of the fuel cell. It is difficult to design the scheme of installing sensors or measuring gaskets inside the fuel cell, and cost for the design is high.

In view of this, it is necessary to provide a current density distribution estimation method and device for a fuel cell, and a computer storage medium, so as to solve the problems that it is difficult to design the schemes known to the inventors by installing sensors or measuring gaskets inside the fuel cell, and that the cost for the design is high.

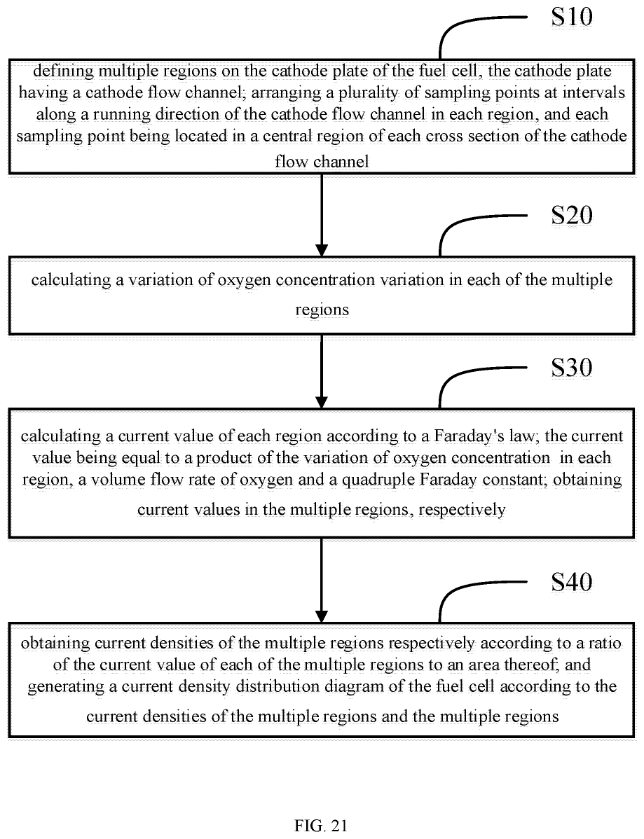

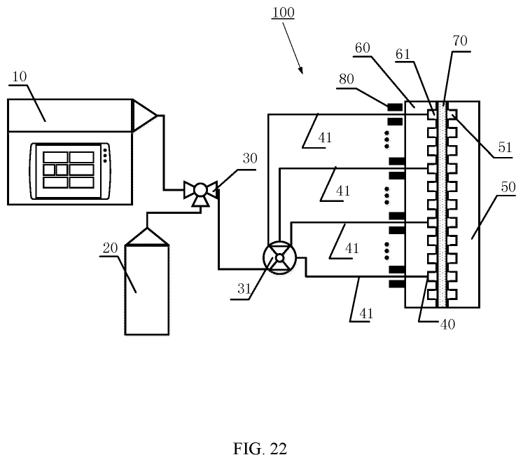

FIG. 21 shows a current density distribution estimation method for a fuel cell. FIG. 22 shows a schematic diagram of the application of the current density distribution estimation method for the fuel cell. In an embodiment of the present disclosure, the method includes following steps.

At step S10, k regions are defined on the cathode plate 60 of the fuel cell. The cathode plate 60 has a cathode flow channel 61. A plurality of sampling points 40 are arranged at intervals along the running direction of the cathode flow channel 61 in each region, and each sampling point 40 is located in the central region of each cross section of the flow channel.

In this step, each of the sampling points 40 is located in the central region of the cross section of the flow channel, which can be understood that the sampling pipes 41 pass through the flow channel plates provided with the anode flow channel 51 and the cathode flow channel 61. The end point of each sampling pipe 41 extending into the flow channel may directly contact the gas inside the fuel cell. FIG. 3, FIG. 4, and FIG. 5 are schematic diagrams illustrating the distribution positions of three types of sampling points in the parallel flow channels on the anode plate. In addition to the sampling points arranged at the cathode inlet 1, the anode outlet 3, the anode inlet 4, and the cathode outlet 6 of the fuel cell, the plurality of sampling points 40 also include those arranged in the flow channel plates provided with the anode flow channel 51 and the cathode flow channel 61. By means of the sampling points 40 arranged in the flow channel plates provided with the anode flow channel 51 and the cathode flow channel 61, gas samples may be obtained at different positions inside the fuel cell.

FIG. 6 to FIG. 8 are schematic diagrams illustrating the distribution positions of three types of sampling points in the parallel flow channels on the cathode plate. FIG. 8 shows the distribution of sampling points in k regions (k=10). It can be understood that the distribution manner of the sampling points 40 may also be anyone else. For example, the sampling point 40 may be arranged at any position of the boundary of each region. When the sampling points 40 are arranged, the sampling points 40 may be arranged closely, or may be arranged at intervals of one flow channel or two flow channels.

In addition, the flow channels on the anode plate 50 and the cathode plate 60 may be arranged in many ways, for example, the flow channels may be snake-like flow channels or interdigitated flow channels. The sampling points 40 may be arranged in the anode flow channels 51 and the cathode flow channels 61 in many ways. FIG. 12 shows a schematic diagram of the distribution positions of the sampling points in the snake-like flow channels on the cathode plate. FIG. 19 shows a schematic diagram of the distribution positions of the sampling points in the interdigitated flow channels on the cathode plate.

At step S20, a variation of oxygen concentration in each of the k regions is calculated.

The variation of oxygen concentration in each region may be determined according to a difference between a concentration of oxygen entering each region and a concentration of oxygen flowing out of each region. In another embodiment, the variation of oxygen concentration in each region may also be a variation of oxygen concentration within a certain period of time, which, specifically, may be the oxygen concentration value at a later time point minus the oxygen concentration in a previous time period.

At step S30, a current value of each region is calculated according to Faraday's law, where the current value is equal to a product of the variation of oxygen concentration in a region, a volume flow rate of oxygen and a quadruple Faraday constant, and the current values in the k regions are obtained respectively.

In this step, the current value of a region is calculated according to the Faraday's law, and this calculation process is performed on the basis of the gas concentration variation in the cathode flow channel 61, which is obtained at the step S20. In this embodiment, the current values of the k regions may be identical or different due to many influencing factors. For example, the oxygen concentrations in the cathode flow channels 61 are different, and the positions or areas of the k regions are different, which may cause the current values of the regions to be different.

At step S40, the current densities of the k regions are obtained respectively according to a ratio of the current value of each of the k regions to an area thereof, and a current density distribution diagram of the fuel cell is generated according to the current densities of the k regions and the k regions.

In this step, the current density of each region may be accurately obtained, and the current density distribution diagram may be drawn. The current density distribution diagram of the fuel cell can guide the use of the fuel cell.

In this embodiment of the current density distribution estimation method for the fuel cell, under the conditions that no other sensors or no other sensor gaskets are provided, current densities in different regions are calculated on the basis of the sampled results of the plurality of sampling points 40, so as to obtain the current density distribution for the individual cell of the fuel cell. The current density distribution estimation method for the fuel cell of the present disclosure can accurately obtain the current density distribution diagram for the fuel cell.

In an embodiment, in each region, the plurality of sampling points 40 are arranged in the cathode flow channels 61 of the fuel cell at identical intervals along the running direction of the cathode flow channel.

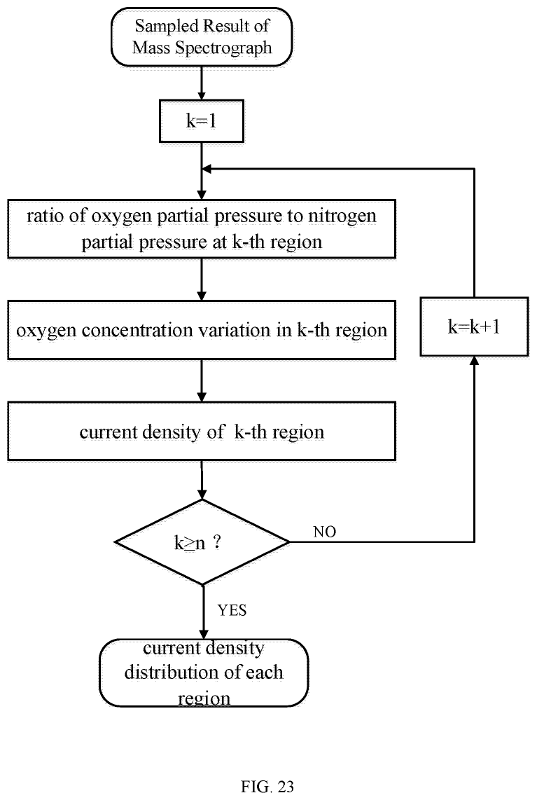

In this embodiment, for the arrangement of the plurality of sampling points 40, please refer to the following drawings. As shown in FIG. 3, FIG. 4, FIG. 6, FIG. 7 and FIG. 23, the plurality of sampling points 40 are arranged in the cathode flow channels 61 of the fuel cell at identical intervals and along the running direction of the corresponding flow channel. FIG. 3 and FIG. 6 show the sampling points 40 distributed at identical intervals without considering the curved structure of each flow channel. FIG. 4, FIG. 7 and FIG. 23 show the sampling points 40 distributed at identical intervals considering the curved structure of each flow channel.

In this embodiment, the plurality of sampling points 40 arranged at identical intervals along the running direction of the corresponding flow channel in the fuel cell plate can realize sampling the gas inside the fuel cell as a whole, and the sampled data are more comprehensive and more accurate for guiding the selection of operating conditions of the fuel cell.

In an embodiment, the variation of oxygen concentration in each region is equal to a difference between the concentration of oxygen entering each region and the concentration of oxygen flowing out of each region. Where, the concentration of the oxygen entering the region is equal to the average oxygen concentration of the plurality of sampling points 40 arranged at an entry boundary of the region. The concentration of the oxygen flowing out of the region is equal to the average oxygen concentration of the plurality of sampling points 40 arranged at the exit boundary of the region.

In this embodiment, the step of calculating the oxygen concentration in the region is simplified. The variation of the oxygen concentration in each region is equal to the average oxygen concentration of the plurality of sampling points 40 arranged at the entry boundary of each region minus the average oxygen concentration of the plurality of sampling points 40 arranged at the exit boundary of the corresponding region.

In an embodiment, the oxygen concentration at a sampling point 40 is equal to a ratio of an oxygen partial pressure at the sampling point 40 to the nitrogen partial pressure at the corresponding sampling point 40, multiplied by the nitrogen concentration at the sampling point 40. When the gas flows through the cathode flow channel 61, the nitrogen concentration does not change.

In an embodiment, I=(n×F×z)/t is obtained by combining the Faraday's law: m=Q/F×M/z, Q=It, and n=m/M, where m denotes a mass of a reactant gas, Q denotes a quantity of electric charge transferred during a reaction, F denotes a Faraday constant, M denotes a molar mass of the reactant gas, z denotes the number of electrons to be transferred for each reactant gas molecule, n denotes an amount of substance in the reactant gas, I denotes a current value, and t denotes a time.

By combining n=c×V and V=W×t, I=c×W×F×z is obtained, where t denotes a time for the gas to flow through the flow channel, c denotes a molar concentration of the reactant gas, V denotes a volume of the gas flowing through the flow channel, W denotes a flow rate of the gas flowing through the flow channel, and z denotes the number of electrons to be transferred for each reactant gas molecule.

By combining I=c×W×F×z and the number 4 of electrons required to be transferred for the oxygen molecule of the cathode reactant gas in the reaction process, the current value of a region Iₖ=ΔC_{O}_{₂}^{k}×W×4F is obtained.

In this embodiment, the current value of each region of the cathode plate 60 of the fuel cell is calculated, where m denotes a mass of oxygen, Q denotes the quantity of electric charge transferred during the reaction, F denotes the Faraday constant, M denotes the molar mass of oxygen, and z denotes the number of electrons to be transferred for each oxygen molecule, n denotes the amount of substance of oxygen, I denotes the current value, and t denotes the time.

With reference to FIG. 23, in a specific embodiment, by calculating the gas concentration variation of the cathode plate 60 of the fuel cell, the distribution diagram of the current density inside the fuel cell is finally obtained. The following specific steps are included.

At step (1), an oxygen partial pressure x_{O}_{₂}^{i,k} and a nitrogen partial pressure x_{N}_{₂}^{i,k} at each of the plurality of sampling points 40 at a k-th region boundary are obtained. Where k is a positive integer less than or equal to N. In this embodiment, the oxygen partial pressure and the nitrogen partial pressure may be obtained by the sampling device 10 shown in FIG. 2. Since the nitrogen is relatively stable, a change in the nitrogen concentration C_{N}_{₂} is not considered.

At step (2), the oxygen concentration C_{O}_{₂}^{i,k} at each sampling point 40 is calculated, and equal to

$$\frac{{x}_{{O}_{2}}^{i , k}}{{x}_{{N}_{2}}^{i , k}} \times {C}_{{N}_{2}} .$$

At step (3), the oxygen concentration at the k-th region boundary is calculated, and the oxygen concentration C_{O}_{₂}^{k} of the k-th region boundary is an average value of the oxygen concentration of all the sampling points 40 at the k-th region boundary.

At step (4), the variation of oxygen concentration ΔC_{O}_{₂}^{k} in the k-th region is calculated, and the variation of oxygen concentration ΔC_{O}_{₂}^{k} in the k-th region is equal to a concentration of oxygen entering the k-th region boundary minus a concentration of oxygen flowing out of the k-th region boundary.

At step (5), the current value of the k-th region is calculated according to an equation Iₖ=ΔC_{O}_{₂}^{k}×W×4F, where W denotes the volume flow rate (measurable) of the oxygen, and F denotes the Faraday constant (known quantity).

At step (6), the current density J, of the k-th region is calculated by

$${J}_{k} = \frac{{I}_{k}}{{S}_{k}} ,$$

where Sₖ denotes an area of the k-th region. Sₖ is a known quantity obtained when regions of the cathode plate 60 are divided.

Step (1) to step (6) are performed repeatedly to calculate the current densities of the region I, the region II, the region III, the region IV, the region V, the region VI, the region VII, the region VIII, the region IX, and the region X shown in FIG. 8, FIG. 23 and FIG. 24, respectively, and the current density distribution diagram of the fuel cell is generated according to the current densities of different regions.

In this embodiment of the current density distribution estimation method for the fuel cell, under the conditions that no other sensors or no other sensor gaskets are provided, current densities in different regions are calculated on the basis of the sampled results of the plurality of sampling points, so as to obtain the current density distribution for the individual cell of the fuel cell. The current density distribution estimation method for the fuel cell of the present disclosure can accurately obtain the current density distribution diagram for the fuel cell shown in FIG. 24.

In a specific embodiment, a gas sampling process of the fuel cell specifically includes preliminary preparations as follows: supplying air and hydrogen to the fuel cell, setting dew point temperature for humidifying the cathode and the air dry bulb temperature, gradually increasing the air flow rate and the hydrogen flow rate, and increasing the current load, till the working conditions of the fuel cell reach the preset values, and the fuel cell stably operating for an hour. The working conditions of the fuel cell may include: a fuel cell working current of 120 A, a cathode air flow rate of 12 L·min-1, and an air intake dew point temperature of 43° C., an anode hydrogen flow rate of 0.9 L·min-1, not humidified intake air, cooling water, and a cooling water inlet temperature of 60° C.

Open the sampling port of the sampling device 10, open the outlet of the gas cylinder 20, and sweep the pipeline with helium. After the sampled results of the sampling device 10 remains stable for a period of time, close the inlet of the four-way valve 30, which communicates with the gas cylinder 20. At this time, the step of sweeping the sampling pipelines 41 is completed.

At step (1): other ports of the N-way valve 31 (disposed at the anode) are closed, except that the outlet of the N-way valve 31, and the inlet of the N-way valve 31 which communicates with the first sampling point, are opened to sample the gas at the first sampling point.

At step (2): after sampling gas at the first sampling point for a period of time, the inlet of the N-way valve 31 is closed; the outlet of the gas cylinder 20 is opened, and the inlet of the three-way valve 30, which communicates with the gas cylinder 20, is opened; the pipeline is swept with helium for a period of time; the outlet of the gas cylinder 20 is closed, and the inlet of the three-way valve 30, which communicates with the helium gas cylinder 20, is closed; and after the sampling at the first sampling point is completed, the sampling pipeline 41 is swept.

At step (3): the N-way valve 31 and the inlet of the second sampling point are opened to sample gas at the second sampling point. After the sampling at the second sampling point is completed, the sampling pipeline 41 is swept. Step (1) to step (3) are performed repeatedly, and after the sampling pipe 41 is swept each time, switch to a next sampling point, till gas sampling for all sampling points 40 of the anode plate 50 or the cathode plate 60 are completed. When the sampled results are subsequently used, reliable sampled results can be selected to guide the application of the fuel cell.

In the foregoing embodiments, the sampling device 10 may be a mass spectrograph. The mass spectrograph achieves gas sampling for the plurality of sampling points 40 by means of sampling gas at the second sampling point after finishing sampling gas at the first sampling point. The mass spectrograph analyzes the gas sample of each sampling point 40 separately. If the sampling device 10 is changed, sampling and analysis for a plurality of points may also be realized simultaneously. That is, gas at the first sampling point, the second sampling point, and the third sampling point (a plurality of sampling points) may be sampled at the same time.

In an embodiment, the sampling device 10 may be the mass spectrograph. The sampling device 10 is calibrated by using the anode standard gas and the cathode standard gas. The sampling device 10 is calibrated, thereby ensuring the accuracy of the sampled results.

The step of calibrating the sampling device 10 specifically includes: introducing the anode standard gas into the sampling pipelines 41, and analyzing, by the sampling device 10, the gas samples to obtain the first-type sampled result; introducing the cathode standard gas into the sampling pipelines 41, and analyzing, by the sampling device 10, the gas samples to obtain the second-type sampled result.

Repeat the above steps to obtain a plurality of first-type sampled results and a plurality of second-type sampled results. The plurality of first-type sampled results and the plurality of second-type sampled results are analyzed and calculated to obtain a sampling correction coefficient of the sampling device 10, thus completing the calibration of the sampling device 10.

With continuing reference to FIG. 22, an embodiment of the present disclosure provides a gas sampling system for the fuel cell, which includes: an anode plate 50, a membrane electrode 70, a cathode plate 60, a plurality of sampling points 40, and a sampling pipeline 41.

The anode plate 50 has an anode flow channel 51 providing a passage for gas flow. The membrane electrode 70 is arranged on a side of the anode plate 50, where the anode flow channel 51 is disposed. The cathode plate 60 is arranged on a side of the membrane electrode 70, and the side of the membrane electrode 70 is away from the anode plate 50. The cathode plate 60 has a cathode flow channel 61 providing a passage for gas flow. The anode flow channel 51 and the cathode flow channel 60 are not completely enclosed, and each flow channel is similar to a groove, in which gas flows.

The membrane electrode 70 includes a proton exchange membrane for realizing the exchange or recombination of protons in the proton exchange membrane. The membrane electrode 70 further includes an anode gas diffusion layer and an anode catalyst layer, which are arranged on a first side of the proton exchange membrane. The membrane electrode 70 further includes a cathode catalyst layer and a cathode gas diffusion layer, which are arranged on a second side of the proton exchange membrane.

The plurality of sampling points 40 arranged in the anode flow channel 51 and the cathode flow channel 61 are located in the central regions of cross sections of the flow channels. The sampling pipelines 41 are connected to the plurality of sampling points 40, respectively, and are configured to guide the gas inside the fuel cell out. The sampling pipeline 41 is mainly a pipeline drawn from a capillary tube inserted into the flow channel from outside the electrode plate. The sampling pipeline 41 may be a stainless steel capillary tube.

In the proton exchange membrane fuel cell, hydrogen and oxygen undergo an electrochemical reaction to produce water and output electrical energy as well. The basic individual cell structure of the fuel cell may include the anode plate 50, the cathode plate 60, and the membrane electrode 70. The anode flow channel 51 is provided on the anode plate 50. The cathode flow channel 61 is provided on the cathode plate 60. The membrane electrode 70 includes the proton exchange membrane, the catalytic layer and the diffusion layer. The proton exchange membrane is a polymer membrane capable of conducting protons. The catalyst layer is a carbon carrier, to which catalytic platinum adheres. The diffusion layer is mainly made of carbon and polytetrafluoroethylene. The proton exchange membrane, the catalytic layer and the diffusion layer constitute the membrane electrode, which provides a place for the reaction between the hydrogen and the oxygen, and performs functions of conducting electricity and heat. The bipolar plates (including the anode plate 50 and the cathode plate 60) generally include carbon plates or metal plates, and flow channels allowing the gas to flow are engraved on the bipolar plates.

With reference to FIG. 2 again, in an embodiment, a heating cable 80 may also be provided during a real-time gas sampling process for the cathode. The heating cable 80 is arranged around the outer side wall of the sampling pipe 41. In an embodiment, the heating cable 80 may ensure that the sampling pipe 41 is maintained at a temperature of 120° C.

In an embodiment, the fuel cell may include a cell stack formed by individual fuel cells connected in series, and each cell pair includes a plurality of individual fuel cells. In another embodiment, the fuel cell further includes a housing, which is arranged at an outside of the cell stack to protect the cell stack. The housing is shown in FIG. 2 but not labeled. The housing is configured to provide a receiving cavity. In an embodiment, the receiving cavity may be defined by an existing cell housing or a cell pack housing, and realizes a function of fixing in the entire sampling process.

In an embodiment, the gas sampling system of the fuel cell may further include an N-way valve 31. Specifically, the N-way valve 31 may be the one shown in FIG. 2. In another embodiment, a plurality of N-way valves may be further provided, for example, a first N-way valve, a second N-way valve or other valves may be provided. In this embodiment, the plurality of N-way valves are configured to realize the communication of different pipelines. When the pipeline needs to be changed, different N-way valves may be arranged at different positions.

In an embodiment, in order to prevent the water vapor in the sampled gas from condensing into liquid water and blocking the pipeline, thus increasing the sampling time and affecting the sampled results, all the sampling pipes 41 are wound with the heating cable 80, so as to ensure that the sampling pipes 41 are maintained at a temperature of 120° C.

In an embodiment, in order to avoid the influence of gas in the non-designated flow channel during sampling, a contacting surface between an end surface of the sampling pipe 41 and a sampling port of the flow channel is compressed and sealed by an O-shaped sealing ring.

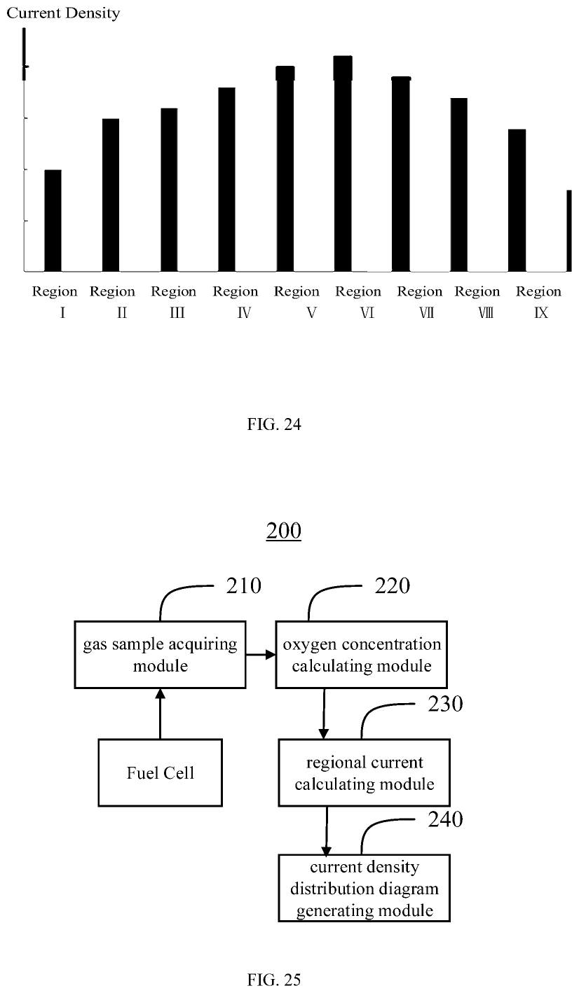

With reference to FIG. 25, in an embodiment of the present disclosure, a current density distribution estimation device 200 for the fuel cell is provided and includes: a gas sample acquiring module 210, an oxygen concentration calculating module 220, a regional current calculating module 230, and a current density distribution diagram generating module 240.

The gas sample acquiring module 210 is configured to acquire gas samples information of a plurality of sampling points 40 arranged in k regions of the cathode plate 60 of the fuel cell at intervals along the running direction of the cathode flow channel 61. The oxygen concentration calculating module 220 is configured to calculate the variation of oxygen concentration in each of the k regions. The regional current calculating module 230 is configured to calculate the current value of each region. The current density distribution diagram generating module 240 is configured to generate a current density distribution diagram of the k regions in the fuel cell.

An embodiment of the present disclosure provides a computer equipment, including a memory and a processor, and computer programs stored in the memory. When the processor executes the computer programs, the steps of the method in any one of the foregoing embodiments are performed.

An embodiment of the present disclosure provides a computer-readable storage medium on which computer programs are stored. When the computer programs are executed by a processor, the steps of the method in any one of the above embodiments are performed.

In a third embodiment, the material composition state of each individual cell is inconsistent during operation of the fuel cell, which is mainly caused by the unevenness of the gas distribution and the individual difference between the individual cells. The individual cell of the fuel cell has a great impact on the service life of the entire cell stack. For this reason, in the process of fuel cell modeling, the unevenness of the internal state of the individual cell of the fuel cell along the running direction of the flow channel and the individual difference between the individual cells should be considered.

A numerical model for the fuel cell may reflect a transfer process, an electrochemical process, and a heat transfer process of each material component inside the fuel cell in more detail. The solutions known to the inventors include an optimization processing method for a model of the proton exchange membrane fuel cell, and in this method, the state of the fuel cell is considered to be consistent, and the differences between the individual cells of the fuel cell are not taken into account.

In view of the problem that, in the solutions known to the inventors, the state of the fuel cell is considered to be consistent, but the differences between the individual cells of the fuel cell are not taken into account, it is necessary to provide a calibration method, a calibration device for an internal state model of the fuel cell, and computer equipment.

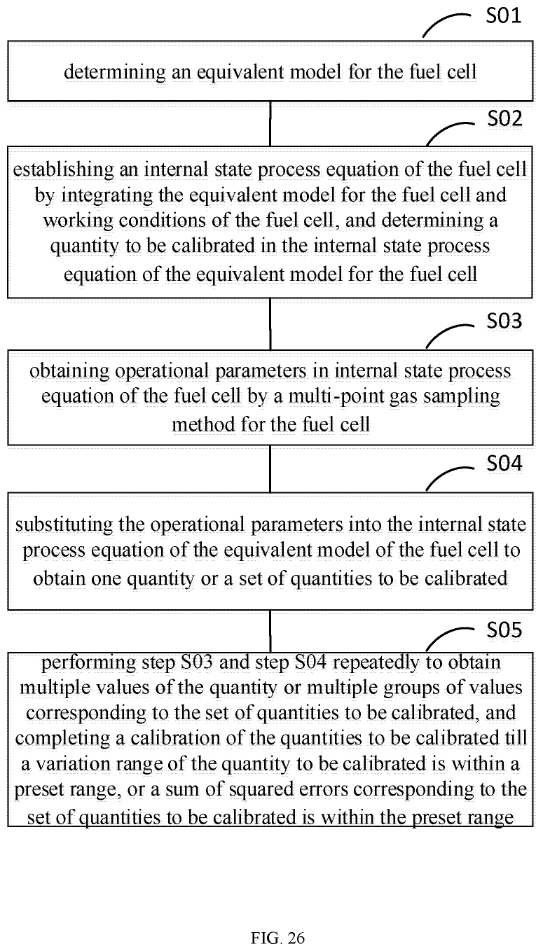

With reference to FIG. 26, an embodiment of the present disclosure provides a calibration method for an internal state model of the fuel cell, including following steps.

At step S01, an equivalent model for the fuel cell is determined. In this step, based on different parameter settings or different views of research, different equivalent models for the fuel cells can be obtained. For example, in the present disclosure, a model for the fuel cell may be a single-flow-channel and multi-cavity model or a model of difference between a plurality of flow channels. For another example, a single-phase flow model for the fuel cell or an M-dimensional, N-phase, multi-component model for the fuel cell can be established.

At step S02, by integrating the equivalent model for the fuel cell and the working conditions of the fuel cell, an internal state process equation of the fuel cell is established, and the quantity to be calibrated in the internal state process equation of the equivalent model for the fuel cell is determined.

In this step, the internal state equation of the fuel cell can be determined according to a voltage condition or a current condition of the fuel cell. The quantity to be calibrated in the internal state process equation is found. The number of the quantity to be calibrated can be one or more, which is not limited herein.

At step S03, operational parameters in internal state process equation of the fuel cell are obtained by a multi-point gas sampling method for the fuel cell. In this step, the operational parameters may be data obtained by the multi-point gas sampling system for the fuel cell. For example, the operational parameter may be the gas flow rate from the cathode inlet cavity into the cathode outlet cavity, the discharged gas flow rate of the cathode outlet cavity, the gas pressures at inlets of different flow channels on the cathode, the gas pressures at outlets of different flow channels on the cathode, and one or more distances between the initial flow channel and different flow channels.

At step S04, the operational parameters are substituted into the internal state process equation of the equivalent model of the fuel cell, to obtain one quantity or a set of the quantities to be calibrated. The calculation process in this step can be implemented in combination with modules or computer programs.

At step S05, the step S03 and the step S04 are repeated to obtain a plurality of values of the quantity or a plurality of groups of values corresponding to the set of quantities to be calibrated, and the calibration of the quantity to be calibrated is completed till a variation range of the quantity to be calibrated is within a preset range, or a sum of squared errors corresponding to the set of quantities to be calibrated is within the preset range.

The calibration method for an internal state model of the fuel cell provided in this embodiment includes determining the equivalent model for the fuel cell. By integrating the equivalent model for the fuel cell and the working conditions of the fuel cell, the internal state process equation of the fuel cell is established, and the quantity to be calibrated in the internal state process equation of the equivalent model for the fuel cell is determined. The operational parameters in the internal state process equation of the fuel cell are obtained. The operational parameters are substituted into the internal state process equation of the equivalent model of the fuel cell, to obtain one quantity or a set of quantities to be calibrated. The plurality of values of the quantity or a plurality of groups of values corresponding to the set of quantities to be calibrated are repeatedly obtained, and the calibration of the quantity to be calibrated is completed till the variation range of the quantity to be calibrated is within the preset range, or the sum of squared errors corresponding to the set of quantities to be calibrated is within the preset range.

In this embodiment, in view of the unevenness and the difference of the individual cells each with a large-area fuel cell, the calibration method for the internal state model is proposed. A set of experiments of steady-state gas sampling are performed, and the model for the individual cell of the fuel cell is calibrated by means of measuring and analyzing the internal state of the fuel cell, which has a certain significance and value for studying the unevenness of a single channel in the individual cell with large area and a plurality of flow channels, and for studying the difference between different flow channels of the fuel cell.

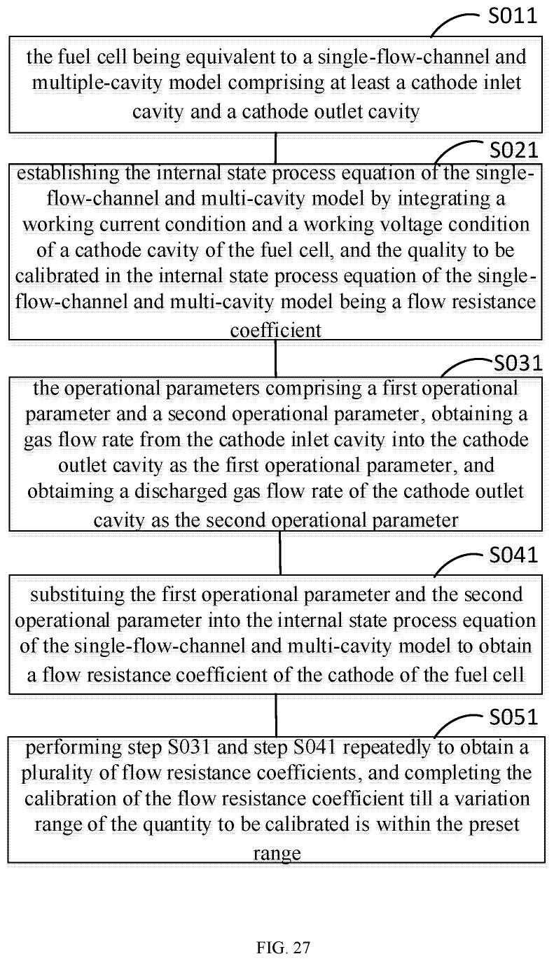

With reference to FIG. 27, in an embodiment, the calibration method for the internal state model of the fuel cell includes following steps.

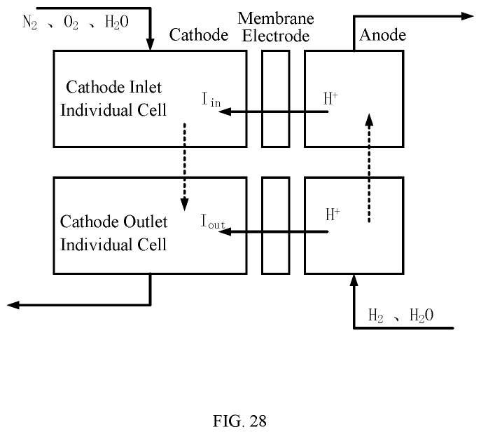

At step S011, the fuel cell is equivalent to a single-flow-channel and multiple-cavity model including at least a cathode inlet cavity and a cathode outlet cavity. The single-flow-channel and multi-cavity model provided in this step is shown in FIG. 28. FIG. 28 shows a single-flow-channel and multi-cavity structure equivalent to an individual cell of the fuel cell. FIG. 28 shows only two cavities of the individual cell of the cathode inlet and the individual cell of the cathode outlet. Other cavities between the two cavities of the individual cell of the cathode inlet and the individual cell of the cathode outlet are defined. It can be understood that, according to different design requirements, the number of the cavities of each individual cell of the fuel cell maybe more or less optionally.

At step S021, by integrating a working current condition and a working voltage condition of the cathode cavity of the fuel cell, the internal state process equation of the single-flow-channel and multi-cavity model is established, and the quality to be calibrated in the internal state process equation of the single-flow-channel and multi-cavity model is a flow resistance coefficient.

In an embodiment of this step, the working current condition provided is:

$${i}_{i n} {A}_{fc , in} + {i}_{o u t} {A}_{f c , o u t} = {I}_{l o a d} \qquad Equation ( 1 )$$

Where, A_{fc,in} is an active area of the inlet cavity of the fuel cell and is a known quantity. A_{fc,out} is an active area of the outlet cavity of the fuel cell. I_{load} is a load current and is a known quantity. iᵢₙ is a current density in the cathode inlet cavity, and iₒᵤₜ is a current density in the cathode outlet cavity.

The working voltage condition is:

$$\frac{R T}{{α}_{c} F} ln [ \frac{{s}_{stop} {i}_{in}}{( {s}_{stop} - {s}_{in} ) a {i}_{0}^{ref}} \times \frac{{C}_{ref}^{{O}_{2}}}{{C}_{ca , in}^{{O}_{2}} - \frac{{i}_{in}}{4 F} [ \frac{{L}_{gdl}}{{{D}_{{O}_{2}}^{e f f} ( 1 - {s}_{in} )}^{2}} + \frac{1}{{h}_{{O}_{2}}} ]} ] - {i}_{in} {R}_{in} = \\ \frac{R T}{{α}_{c} F} ln [ \frac{{s}_{stop} {i}_{out}}{( {s}_{stop} - {s}_{out} ) a {i}_{0}^{ref}} \times \frac{{C}_{ref}^{{O}_{2}}}{{C}_{ca , out}^{{O}_{2}} - \frac{{i}_{out}}{4 F} [ \frac{{L}_{gdl}}{{{D}_{{O}_{2}}^{eff} ( 1 - {s}_{out} )}^{2}} + \frac{1}{{h}_{{O}_{2}}} ]} ] - {i}_{out} {R}_{out} \qquad Equation ( 2 )$$

Where, R is the ideal gas constant, F is the Faraday constant, T is an internal temperature of the fuel cell, L_{gdl} is a thickness of a gas diffusion layer, α_{c} is a reaction transfer coefficient of the cathode, sₛₜₒₚ is a liquid water saturation when the fuel cell stops working under the influence of flooding, sᵢₙ is a liquid water saturation at the cathode inlet, sₒᵤₜ is a liquid water saturation at the cathode outlet, and α is a water activity. The water activity α is equal to a ratio of a saturation of gaseous water to a concentration of saturated water vapor at the current temperature. i₀^{ref} is a reference current density. h_{O}_{₂} is a convective mass transfer coefficient of oxygen, and the convective mass transfer coefficient h_{O}_{₂} of the oxygen is related to the gas flow rate. Rᵢₙ is ohmic resistance of the inlet cavity, Rₒᵤₜ is ohmic resistance of the outlet cavity, and D_{O}_{₂}^{eff} is an effective diffusion coefficient of oxygen. C_{ref}^{O}^{₂} is a reference concentration of oxygen. The above parameters are all known quantities in the single-flow-channel and multi-cavity model. C_{ca,in}^{O}^{₂} is an oxygen concentration in the cathode inlet cavity and may be calculated by

$${C}_{ca , in}^{{O}_{2}} = \frac{{p}_{ca , in}^{{O}_{2}}}{R {T}_{fc}} \cdot {C}_{ca , out}^{{O}_{2}}$$

is an oxygen concentration in the cathode outlet cavity and may be calculated by

$${C}_{ca , out}^{{O}_{2}} = \frac{{p}_{ca , out}^{{O}_{2}}}{R {T}_{f c}} \cdot {i}_{in}$$

is the current density in the cathode inlet cavity, and iₒᵤₜ is the current density in the cathode outlet cavity, and they can be calculated by integrating the equations (1) and (2).

In an embodiment of this step, the internal state process equation of the single-flow-channel and multi-cavity model includes a gas dynamic process model of the cathode inlet cavity and a gas dynamic process model of the cathode outlet cavity.

The gas dynamic process model of the cathode inlet cavity is:

$$\begin{matrix}\frac{d {p}_{ca , in}^{{N}_{2}}}{d t} = \frac{2 R {T}_{f c}}{{V}_{c a}} ( {W}_{air} ( 1 - {x}_{air , in}^{{O}_{2}} ) - {W}_{12} ( 1 - {x}_{ca , in}^{{O}_{2}} ) ) & Equation ( 3 ) \\ and & \\ \frac{d {p}_{ca , in}^{{O}_{2}}}{d t} = \frac{2 R {T}_{f c}}{{V}_{c a}} ( {W}_{air} {x}_{sup}^{{O}_{2}} - {W}_{12} {x}_{ca , in}^{{O}_{2}} - \frac{{i}_{in}}{4 F} {A}_{fc , in} ) & Equation ( 4 )\end{matrix}$$

In addition, integrate the following equations (5) to (7):

$$\begin{matrix}{P}_{ca , in} = {p}_{ca , in}^{{N}_{2}} + {p}_{ca , in}^{{O}_{2}} + {p}_{sat} & Equation ( 5 ) \\ {x}_{ca , in}^{{O}_{2}} = \frac{{p}_{ca , in}^{{O}_{2}}}{{p}_{ca , in}^{{N}_{2}} + {p}_{ca , in}^{{O}_{2}}} & Equation ( 6 ) \\ {C}_{ca , in}^{{O}_{2}} = \frac{{p}_{ca , in}^{{O}_{2}}}{R {T}_{f c}} & Equation ( 7 )\end{matrix}$$

where,

$$\frac{d {p}_{ca , in}^{{N}_{2}}}{d t}$$

is the pressure change rate of nitrogen in the cathode inlet cavity, and

$$\frac{d {p}_{ca , in}^{{O}_{2}}}{d t}$$

is the pressure change rate of the oxygen in the cathode inlet cavity. p_{ca,in}^{N}^{₂} is a pressure of the nitrogen in the cathode inlet cavity, and p_{ca,in}^{O}^{₂} is a pressure of the oxygen in the cathode inlet cavity, and they may be calculated by integrating the equations (3), (4), (5), (6), and (13), then they are substituted into the equation (7) to obtain p_{ca,in}^{O}^{₂}, namely the oxygen concentration in the cathode inlet cavity. R is the ideal gas constant. T_{fc} is the internal temperature of the fuel cell, which may be directly measured. V_{ca} is a set value of a volume of the cathode control body. Wₐᵢᵣ is a intake flow of dry air and may be directly measured by a gas flow sensor disposed at the front of the air compressor. x_{air,in}^{O}^{₂} is an oxygen volume fraction in the dry air at the inlet and may be obtained through experience. W₁₂ is a gas flow rate from the cathode inlet cavity into the cathode outlet cavity and can be calculated by the following equation (13). x_{ca,in}^{O}^{₂} is an oxygen partial pressure at the cathode inlet and is expressed by the following equation (8). xₛᵤₚ^{O}^{₂} is a set oxygen partial pressure in the gas supplied to the cathode inlet and is a known quantity. iᵢₙ is the current density (solved by integrating equations (1) and (2)) in the cathode inlet cavity. A_{fc,in} is the active area of the cathode inlet cavity and is a known quantity. p_{ca,in} is the gas pressure at cathode inlet (calculated by equation (5)). pₛₐₜ is a saturated water vapor pressure and is a known quantity. C_{ca,in}^{O}^{₂} is an oxygen concentration in the cathode inlet cavity (calculated by equation (7)).

The gas dynamic process model of the cathode outlet cavity is:

$$\begin{matrix}\frac{d {p}_{ca , out}^{{N}_{2}}}{d t} = \frac{2 R {T}_{f c}}{{V}_{c a}} ( {W}_{12} ( 1 - {x}_{ca , in}^{{O}_{2}} ) - {W}_{rm} ( 1 - {x}_{ca , out}^{{O}_{2}} ) ) & Equation ( 8 ) \\ \frac{d {p}_{ca , out}^{{O}_{2}}}{d t} = \frac{2 R {T}_{f c}}{{V}_{c a}} ( {W}_{12} {x}_{ca , in}^{{O}_{2}} - {W}_{rm} {x}_{ca , out}^{{O}_{2}} - \frac{{i}_{out}}{4 F} {A}_{fc , out} ) & Equation ( 9 )\end{matrix}$$

In addition, integrate the following equations (10) to (14):

$$\begin{matrix}{p}_{ca , out} = {p}_{ca , out}^{{N}_{2}} + {p}_{ca , out}^{{O}_{2}} + {p}_{sat} & Equation ( 10 ) \\ {x}_{ca , out}^{{O}_{2}} = \frac{{p}_{ca , out}^{{O}_{2}}}{{p}_{ca , out}^{{N}_{2}} + {p}_{ca , out}^{{O}_{2}}} & Equation ( 11 ) \\ {C}_{ca , out}^{{O}_{2}} = \frac{{p}_{ca , out}^{{O}_{2}}}{R {T}_{f c}} & Equation ( 12 ) \\ {W}_{12} = 2 {k}_{c a} ( {p}_{ca , in} - {p}_{ca , out} ) \frac{{p}_{ca , in} - {p}_{s a t}}{R {T}_{f c}} & Equation ( 13 ) \\ {W}_{rm} = 2 {k}_{c a} ( {p}_{ca , out} - {p}_{rm} ) \frac{{p}_{ca , out} - {p}_{s a t}}{R {T}_{f c}} & Equation ( 14 )\end{matrix}$$

Where

$$\frac{d {p}_{ca , out}^{{N}_{2}}}{d t}$$

is the pressure change rate of the nitrogen in the cathode outlet cavity, and

$$\frac{d {p}_{ca . out}^{{O}_{2}}}{d t}$$

is the pressure change rate of the oxygen in the cathode outlet cavity. By integrating equations (8), (9), (10), (11), (12), (13), and (14), the pressure of the nitrogen in the cathode outlet cavity p_{ca,out}^{N}^{₂} and the pressure of the oxygen in the cathode outlet cavity p_{ca,out}^{O}^{₂} can be calculated. By substituting p_{ca,out}^{O}^{₂} into the equation (12), the oxygen concentration in the cathode outlet cavity C_{ca,out}^{O}^{₂} is obtained. R is the ideal gas constant. T_{fc} is the internal temperature of the fuel cell and may be measured directly. V_{ca} the set value of a volume of the cathode control body. W₁₂ is the gas flow rate from the cathode inlet cavity into the cathode outlet cavity and can be calculated by the equation (13). Wᵣₘ is a discharged gas flow rate at a rear of the cathode and is expressed by equation (14). x_{ca,in}^{O}^{₂} is the oxygen partial pressure at the cathode inlet and is calculated by the equation (6). x_{ca,out}^{O}^{₂} is the oxygen partial pressure in the cathode outlet cavity and is expressed by the equation (11). iₒᵤₜ is the current density in the cathode outlet cavity and is obtained by integrating the equations (1) and (2). A_{fc,out} is the active area of the cathode outlet cavity and is a known quantity. p_{ca,out} is the gas pressure in the cathode outlet cavity and may be expressed by the equation (10). pₛₐₜ is the saturated water vapor pressure and is a known quantity. C_{ca,out}^{O}^{₂} is the oxygen concentration in the cathode outlet cavity and may be calculated by the equation (12).

At step S031, the operational parameters include a first operational parameter and a second operational parameter, the gas flow rate W₁₂ from the cathode inlet cavity into the cathode outlet cavity is obtained as the first operational parameter, and the discharged gas flow rate Wᵣₘ of the cathode outlet cavity is obtained as the second operational parameter.

At step S041, the first operational parameter and the second operational parameter are substituted into the internal state process equation of the single-flow-channel and multi-cavity model to obtain a flow resistance coefficient k_{ca} of the cathode of the fuel cell.

At step S051, the step S031 and the step S041 are repeated to obtain a plurality of flow resistance coefficients k_{ca}, and the calibration of the flow resistance coefficient is completed till the variation range of the quantity to be calibrated is within the preset range.

In this embodiment, during the calibration, W₁₂ and Wᵣₘ in the equations (13) and (14) are measured by the flow sensors arranged at the cathode inlet and a rear valve of the cathode, respectively. C_{ca,in}^{O}^{₂} and C_{ca,out}^{O}^{₂} may be measured by multi-point gas sampling experiments, and then p_{ca,in}^{O}^{₂} and p_{ca,out}^{O}^{₂} may be calculated by the equations (7) and (12), respectively. p_{ca,in}^{N}^{₂} and p_{ca,out}^{N}^{₂} may be measured by the multi-point gas sampling experiments. pₛₐₜ is a known quantity, and pᵣₘ may be directly measured. p_{ca,in} and p_{ca,out} may be calculated by the equations (5) and (10), respectively. p_{ca,in} and p_{ca,out} are substituted into the equation (13) or equation (14) to obtain k_{ca}. A plurality of experiments are performed to calculate the average value, and the calibration is completed.

More broadly, the single-flow-channel and multi-cavity model is similar to the single-flow-channel and two-cavity model. The uneven distribution of substances in the flow channel is mainly considered, and the flow channel is divided into a plurality of cavities along the direction of the gas flow, so as to establish a single-flow-channel and multi-cavity model. The specific calibration method may be similar to the method including step S011-step S051.

In this embodiment, a single-flow-channel and multi-cavity model is provided, to establish the internal state process equation of the single-flow-channel and multi-cavity model, and realize the calibration process for the quantity to be calibrated in the internal state process equation of the single-flow-channel and multi-cavity model. The quantity to be calibrated in the model is the flow resistance coefficient. In this embodiment, a plurality of the flow resistance coefficients can be obtained, and the calibration of the flow resistance coefficient is completed till the variation range of the quantity to be calibrated is within the preset range. In the present disclosure, the calibration of the individual cell model for the fuel cell is achieved by means of a multi-point gas sampling method and device for the fuel cell. The multi-point gas sampling method for the fuel cell will be introduced specifically hereafter with reference to FIG. 2-FIG. 6.

In an embodiment, it is determined whether a plurality of values of the quantity or a plurality of groups of values corresponding to the set of quantities to be calibrated need to be further obtained by following steps: obtaining all the flow resistance coefficients in the previous steps;

arranging the flow resistance coefficients in a time sequence, a flow resistance coefficient of a previous state is subtracted from a flow resistance coefficient of a latter state, to obtain a flow resistance coefficient variation;

judging whether the flow resistance coefficient variation is within a preset range;

if the flow resistance coefficient variation is within a range of ±0.0001, an average value is taken as a calibrated value of the flow resistance coefficient.

Specifically, the flow resistance coefficient k_{ca} is the flow resistance coefficient of the cathode cavity, which needs to be calibrated by experimental data, and which is determined by a gas viscosity and structural parameters of the cathode of the fuel cell. Step S031 and step S041 are performed repeatedly for several times till the variation of the flow resistance coefficient is within the range of ±0.0001, and the average value is taken as the calibrated value of the flow resistance coefficient. In an embodiment, the value of the flow resistance coefficient is 3.457×10⁻⁵ m³·S⁻¹·Pa⁻¹. In other embodiments, the range of the flow resistance coefficient may be from 1×10⁻⁵ m³·S⁻¹·Pa⁻¹ to 1×10⁻⁴ m³·S⁻¹·Pa⁻¹.

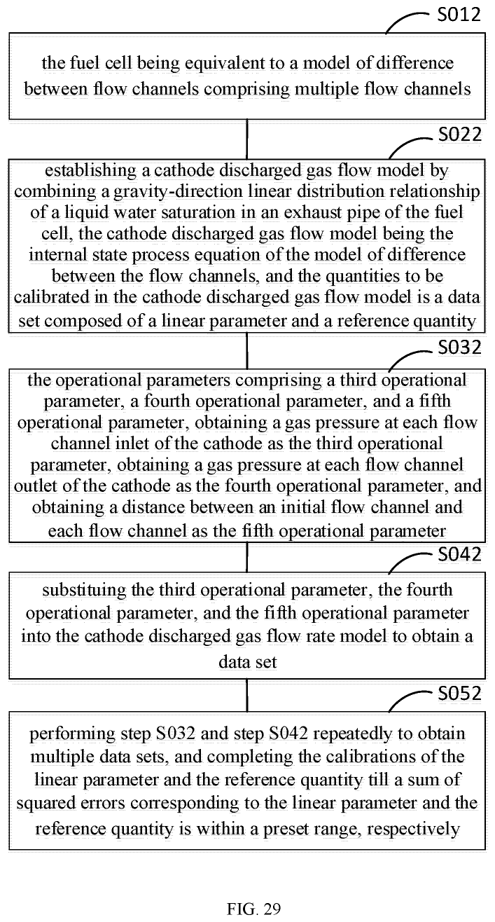

With reference to FIG. 29, in an embodiment, the calibration method for an internal state model of the fuel cell includes following steps.

At step S012, the fuel cell is equivalent to a model of difference between flow channels including a plurality of flow channels. The model of difference between flow channels of the individual cell of the fuel cell provided in this step is shown in FIG. 30. FIG. 30 shows three flow channels, and three different cavities are shown in each flow channel. It can be understood that, according to different design requirements, the number of flow channels provided in each individual cell of the fuel cell can be further increased, and the number of the cavities set for each flow channel can be further increased.

At step S022: by combining a gravity-direction linear distribution relationship of the liquid water saturation in an exhaust pipe of the fuel cell, a cathode discharged gas flow model is established, where the cathode discharged gas flow model is the internal state process equation of the model of difference between the flow channels, and the quantities to be calibrated in the cathode discharged gas flow model is a data set composed of a linear parameter k and a reference quantity b.

In an embodiment, the cathode discharged gas flow model is:

$${W}_{ca , out} = \frac{{p}_{ca , in} - {p}_{ca , out}}{{k}_{1} + {k}_{2} ( 1 + \frac{{ρ}_{1}}{{ρ}_{g}} s ) {μ}_{g}} \qquad Equation ( 15 )$$

Integrate the following equation (16):

$$s = k x + b \qquad Equation ( 16 )$$

where, W_{ca,out} is the gas flow rate at each flow channel outlet of the cathode, and p_{ca,in} is the gas pressure at each flow channel inlet of the cathode and may be measured. p_{ca,out} is the gas pressure at each flow channel outlet of the cathode and may be measured. k₁ is an orifice flow rate coefficient of the flow channel and is a known quantity. k₂ is an orifice flow coefficient of the exhaust manifold pipe and is a known quantity. ρ₁ is a density of liquid water. ρ_{g} is a density of discharged gas. μ_{g} is a gas viscosity and is a known quantity. s is the liquid water saturation of each flow channel. Assuming that the liquid water saturation of each flow channel is linearly distributed and satisfies s=kx+b, where, x is the distance between the initial flow channel and each flow channel and can be measured. k is a linear parameter and needs to be calibrated by experimental data. b is a reference quantity and needs to be calibrated by experimental data.

At step S032, the operational parameters include a third operational parameter, a fourth operational parameter, and a fifth operational parameter, the gas pressure p_{ca,in} at each flow channel inlet of the cathode is obtained as the third operational parameter, and the gas pressure at each flow channel outlet of the cathode is obtained as the fourth operational parameter, and the distance x between the initial flow channel and each flow channel is obtained as the fifth operational parameter.

At step S042, the third operational parameter, the fourth operational parameter, and the fifth operational parameter are substituted into the cathode discharged gas flow rate model to obtain a data set.

At step S052, the step S032 and the step S042 are performed repeatedly, to obtain a plurality of data sets, the calibrations of the linear parameter k and the reference quantity b are completed till the sum of squared errors corresponding to the linear parameter and the reference quantity is within a preset range, respectively.

In the specific calibration process of this embodiment, the parameters that need to be calibrated in this model are the linear coefficient k and the reference quantity b. In the calibration experiment, the gas pressure p_{ca,in} at each flow channel inlet of the cathode and the gas pressure p_{ca,out} at each flow channel outlet of the cathode in the equation (15) may be measured, and the gas flow rate W_{ca,out} at each flow channel outlet of the cathode is measured by the flow sensor arranged in the flow channel outlet. Except for the parameters to be calibrated, other parameters are known. By estimating a set of initial values of k and b, changing the value of the gas pressure p_{ca,in} at each flow channel inlet of the cathode and the distance x between the initial flow channel and each flow channel, and substituting them into the equation to get the gas flow rate at each flow channel outlet of the cathode, until the calculated standard deviation of the gas flow rate W_{ca,out}^{model} at each flow channel outlet of the cathode and the really measured gas flow rate W_{ca,out}^{real} at each flow channel outlet of the cathode is the smallest.

In an embodiment, it may be determined whether a plurality of values of the quantity or a plurality of groups of values corresponding to the set of quantities to be calibrated need to be further obtained by the following steps.

By estimating different values of the linear parameter k and the reference quantity b, and changing the gas pressure p_{ca,in} at each flow channel inlet of the cathode and the distance x between the initial flow channel and each flow channel, the gas flow rate W_{ca,out}^{model} at each flow channel outlet of the cathode is calculated.

The calculated gas flow rate W_{ca,out}^{model} at each flow channel outlet of the cathode and the really measured gas flow rate W_{ca,out}^{real} at each flow channel outlet of the cathode are substituted into the following equation (17):

$${r}^{2} = \sum {( {W}_{ca , out}^{r e a l} - {W}_{ca , out}^{m o d e l} )}^{2} \qquad Equation ( 17 )$$

A sum r² of squared errors corresponding to each set of data is calculated, and a linear parameter k and a reference quantity b are correspondingly determined as an optimal solution when the sum r² of the squared errors is less than 0.001, and the calibration is completed. In an embodiment, the values of the linear parameter k and the reference quantity b may be: k=0.012, b=0.531.

With reference to FIG. 2 to FIG. 6, in a specific embodiment, a multi-point gas sampling system and a sampling method for a fuel cell are provided.

As shown in FIG. 2, the multi-point gas sampling system for the fuel cell includes: an anode plate 50, a membrane electrode 70, a cathode plate 60, a plurality of sampling points 40, and a plurality of sampling pipelines 41.

The anode plate 50 has an anode flow channel 51 providing a passage for gas flow. The membrane electrode 70 is arranged on a side of the anode plate 50, where the anode flow channel 51 is disposed. The cathode plate 60 is arranged on a side of the membrane electrode 70, and the side of the membrane electrode 70 is away from the anode plate 50. The cathode plate 60 has a cathode flow channel 61 providing a passage for gas flow. The anode flow channel 51 and the cathode flow channel 60 are not completely enclosed, and each flow channel is similar to a groove, in which gas flows.

The membrane electrode 70 includes a proton exchange membrane for realizing the exchange or recombination of protons in the proton exchange membrane. The membrane electrode 70 further includes an anode gas diffusion layer and an anode catalyst layer, which are arranged on a first side of the proton exchange membrane. The membrane electrode 70 further includes a cathode catalyst layer and a cathode gas diffusion layer, which are arranged on a second side of the proton exchange membrane.

The plurality of sampling points 40 arranged in the anode flow channel 51 and the cathode flow channel 61 are located in the central regions of cross sections of the flow channels. The sampling pipelines 41 are connected to the plurality of sampling points 40, respectively, and are configured to guide the gas inside the fuel cell out. The sampling pipeline 41 is mainly a pipeline drawn from a capillary tube inserted into the flow channel from outside the electrode plate. The sampling pipeline 41 may be a stainless steel capillary tube.

In the proton exchange membrane fuel cell, hydrogen and oxygen undergo an electrochemical reaction to produce water and output electrical energy as well. The basic individual cell structure of the fuel cell may include the anode plate 50, the cathode plate 60, and the membrane electrode 70. The anode flow channel 51 is provided on the anode plate 50. The cathode flow channel 61 is provided on the cathode plate 60. The membrane electrode 70 includes the proton exchange membrane, the catalytic layer and the diffusion layer. The proton exchange membrane is a polymer membrane capable of conducting protons. The catalyst layer is a carbon carrier, to which catalytic platinum adheres. The diffusion layer is mainly made of carbon and polytetrafluoroethylene. The proton exchange membrane, the catalytic layer and the diffusion layer constitute the membrane electrode, which provides a place for the reaction between the hydrogen and the oxygen, and performs functions of conducting electricity and heat. The bipolar plates (including the anode plate 50 and the cathode plate 60) generally include carbon plates or metal plates, and flow channels allowing the gas and the coolant to flow are engraved on the bipolar plates.

Other cross sections in FIG. 3 and FIG. 6 show a water outlet 5, a cathode outlet 6, a flow channel 7, an anode inlet sampling point 8, an anode outlet sampling point 9 and other sampling points 101 in the flow channel.

In an embodiment, the plurality of sampling points 40 are arranged in the anode flow channels 51 at identical intervals along the running direction of a corresponding flow channel, and arranged in the cathode flow channels 61 at identical intervals along the running direction of a corresponding flow channel.

In an embodiment, the fuel cell includes at least three anode flow channels 51 and at least three cathode flow channels 61. The plurality of sampling points 40 are respectively arranged in the flow channels spaced at intervals of one or more anode flow channels 51, and arranged in the flow channels spaced at intervals of one or more of the cathode flow channels 61.

With reference to FIG. 2 to FIG. 6, the multi-point gas sampling method for the fuel cell includes at least the following steps.

At step S10, a plurality of sampling pipelines 41 and a plurality of sampling points 40 are arranged. The plurality of sampling points 40 are arranged in the cathode inlet 1, the anode outlet 3, the anode inlet 4, the cathode outlet 6 and the anode flow channels 51 and the cathode flow channels 61 of the fuel cell. The plurality of sampling points 40 arranged in the anode flow channel 51 and the cathode flow channel 61 are located in the central regions of cross sections of the flow channels. The sampling pipelines 41 are connected to the plurality of sampling points 40, respectively, and configured to guide the gas inside the fuel cell out.

In this step, arranging the sampling points in the central regions of the cross sections of the flow channels can be understood that the sampling pipes 41 pass through the flow channel plates provided with the anode flow channel 51 and the cathode flow channel 61, and an end point of each sampling pipe 41, which extends into the flow channel, may directly contact the gas inside the fuel cell to be one of the sampling points 40. With reference to FIG. 3 to FIG. 6, in addition to the sampling points arranged at the cathode inlet 1, the anode outlet 3, the anode inlet 4, and the cathode outlet 6 of the fuel cell, the plurality of sampling points 40 also include those arranged in the flow channel plate provided with the anode flow channel 51 and the cathode flow channel 61. By means of the sampling points 40 arranged in the flow channel plates provided with the anode flow channel 51 and the cathode flow channel 61, gas samples may be obtained at different positions inside the fuel cell.

At step S20, reactant gases are introduced into the cathode inlet 1 and the anode inlet 4 respectively, and an electronic load is connected between the anode plate 50 and the cathode plate 60 of the fuel cell.

In this step, a cathode standard gas and an anode standard gas are introduced into the cathode inlet 1 and the anode inlet 4, respectively. After the gases are introduced, a certain electronic load is connected between the cathode plate 60 and the anode plate 50. For example, the electronic load may be a set current of 0 A/cm² to 2 A/cm² output by an individual cell of the fuel cell.

At step S30, the gas samples of the plurality of sampling points 40 are guided out by means of the sampling pipelines 41 to complete gas sampling of the fuel cell.

In this step, the sampling device 10 may be used to obtain the gas samples of the plurality of sampling points 40, which are guided out by means of the sampling pipelines 41. The sampling device 10 may analyze the gas samples and obtain the analysis results to guide the use of the fuel cell.

In this embodiment, the plurality of sampling points 40 are arranged to obtain the gas samples of different locations in the fuel cell respectively, so as to achieve multi-point gas sampling inside the fuel cell, and monitor gas concentrations at different locations inside the fuel cell in real time. The plurality of sampling points 40 are located in the central regions of the cross sections of the anode flow channel 51 and the cathode flow channel 61, and the gas flowing through the flow channels may be accurately obtained. By arranging the plurality of sampling points 40 in the flow channels on the anode plate 50 and the cathode plate 60 of the fuel cell, the gas sample at each point may be obtained. The analysis of contents and concentrations of the gas can help to obtain safer and more reliable working conditions for the fuel cell, thereby ensuring working safety and a service life of the fuel cell, and ensuring the utilization rate of the fuel cell.

In an embodiment of the present disclosure, the calibration method for the internal state model related to a hardware structure of the fuel cell specifically includes:

First, various parameters of experimental conditions are set. The various parameters of the experimental conditions include: a cathode flow rate (standard state) of 5.16 L/min, a cathode inlet dew point temperature of 60° C., a dry bulb temperature of 65° C., a current of 40 A, and a coolant inlet temperature of 59° C.

Second, designed experimental steps are as follows.

(1) Sweep the fuel cell with helium, and set the temperature and the flow rate of the coolant.

(2) Stop sweeping and supply air and hydrogen, set the dew point temperature for humidifying the cathode and the air dry bulb temperature, and gradually increase the air flow rate and the hydrogen flow rate. At the same time, gradually increase the current load till the gas flow rate and the current reach the preset values, and the fuel cell stably operates for a period of time.

(3) Open the sampling port of the sampling device 10, open the outlet of the gas cylinder 20, and sweep the pipeline with helium. The sampling device 10 is a mass spectrograph. After the sampled results of the mass spectrograph remain stable for a period of time, close the outlet of the helium cylinder, and close the inlet of the four-way valve, which communicates with the helium cylinder.

(4) Close all inlets and outlets of the second N-way valve 32, close other ports of the first N-way valve 31 (disposed at the anode), except that an outlet of the first N-way valve 31, and an inlet of the first N-way valve 31, which communicates with the first sampling point, are opened, to sample the gas at the first sampling point.

(5) After gas at the first sampling point is sampled for a period of time, close the inlet of the first N-way valve 31, open the outlet of the gas cylinder 20 (at this time, the gas cylinder 20 is a helium cylinder), open the inlet of the four-way valve 30, which communicates with the gas cylinder 20, sweep the pipeline with helium for a period of time, close the outlet of the helium cylinder, and close the inlet of the four-way valve 30, which communicates with the helium cylinder.

(6) Open the first N-way valve 31 and the inlet of the second sampling point, and sample gas at the second sampling point.

(7) Similarly, after gas sampling is completed, sweep the sampling pipeline, and then switch to the next sampling point, till gas sampling for all sampling points of the anode plate 50 is completed.

(8) Sweep the sampling pipelines 41 with helium. Open the outlet of the second N-way valve 32 (disposed at the cathode plate) and the inlet thereof which communicates with the first sampling point of the cathode plate 60, and start to sample gas.

(9) Repeat step (5) to step (7) till gas sampling for all sampling points of the cathode plate 60 is completed.

Third, the operational parameters are obtained, and the model is calibrated.

The above sampled results are used to calibrate the model. The sampled results are substituted into the single-flow-channel and multi-cavity model or the model of difference between flow channels, and the values of parameters to be calibrated are deduced, thereby obtaining a more accurate single-flow-channel and multi-cavity model and a more accurate model of difference between the flow channels for the individual cell of the fuel cell.

Fourth, the calibrated parameters are tested and verified.

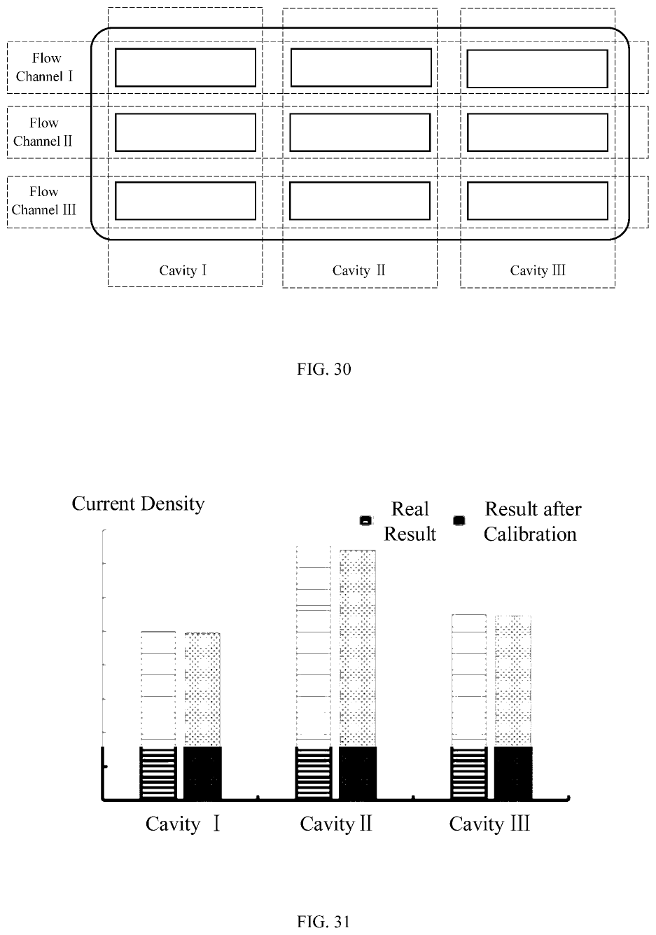

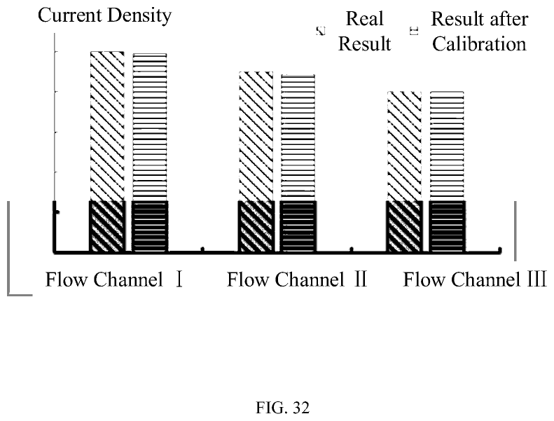

The calibrated single-flow-channel and multi-cavity model and the calibrated model of difference between flow channels are tested and verified. The specific method includes, setting, by means of the model analysis software, the same working conditions for the models as the actual experiment, and comparing the model result with the experimental result. If the results are relatively consistent, then the calibrated model is proved to be effective. Otherwise, the model needs to be revised. The calibrated results are shown in FIG. 31 and FIG. 32.

Another embodiment of the present disclosure provides a calibration device for an internal state model of a fuel cell, including: a fuel cell equivalent model determination unit, a fuel cell internal state process determination unit, an operational parameter acquisition unit, an operational parameter calculation unit, and a loop judgment unit.

The fuel cell equivalent model determination unit is configured to determine a model applicable to the fuel cell. The fuel cell internal state process determination unit is configured to establish an internal state process equation for the fuel cell and determine the quantity to be calibrated in combination with the equivalent model of the fuel cell and the working conditions of the fuel cell. The operational parameter acquisition unit is configured to acquire operational parameters in the internal state process equation of the fuel cell. The operational parameter calculation unit is configured to substitute the operational parameters into the internal state process equation of the single-flow-channel and multi-cavity model to obtain one quantity or one set of quantities to be calibrated. The loop determination unit is configured to determine whether a plurality of values of the quantity or a plurality of groups of values corresponding to the set of quantities to be calibrated need to be further acquired. If an average of the values of the quantity to be calibrated or a sum of squared errors corresponding to the values of the quantities to be calibrated is less than a threshold, then a plurality of values of the quantity to be calibrated or a plurality of groups of values corresponding to the set of quantities to be calibrated are not further acquired.

For the specific steps of calibrating parameters in the internal state model of the fuel cell, which are performed by the calibration device for the internal state model of the fuel cell described in this embodiment, please refer to the aforementioned calibration method for the internal state model of the fuel cell, and they will not be repeated herein.

A computer equipment is provided. The computer equipment includes a memory, a processor, and computer programs stored in the memory. The computer programs, when executed by the processor, cause the processer to perform the steps of any one of the foregoing methods.

A computer readable storage medium is provided. Computer programs are stored on computer readable storage medium. The computer programs, when executed by the processer, cause the processor to perform the steps of any one of the above methods.

It should be understood by the ordinary skilled in the art that, all or part of the processes in the methods of the above embodiments can be implemented through computer programs controlling corresponding hardware. The computer programs can be stored in the non-transitory computer readable storage medium. When the computer programs are executed, they may include the processes in the methods of the above embodiments. Any memory, storage, databases or other medium described in all embodiments provided by the present invention may include non-transitory and/or transitory memory. Non-transitory memory can include Read-Only Memory (ROM), Programmable ROM (PROM), Erasable Programmable ROM (EPROM), Electrically Erasable Programmable ROM (EEPROM), or flash memory. Transitory memory may include Random Access memory (RAM) or external cache memory. Not illustrated as limitation but as explanations, RAM may be any one of Static RAM (SRAM), Dynamic RAM (DRAM), Synchronous DRAM (SDRAM), Double Data Rate SDRAM (DDR SDRAM), Enhanced SDRAM (ESDRAM), Synchronization Link DRAM (SLDRAM), Rambus Direct RAM (RDRAM), Direct Rambus Dynamic RAM (DRDRAM), and Rambus Dynamic RAM (RDRAM).

It should be noted that in the present disclosure, terms like “first” and “second” are only used to distinguish one entity or operation from another entity or operation, and are not intended to necessarily require or imply any actual relationship or order between these entities or operations.

The technical features of the above-mentioned embodiments can be combined arbitrarily. In order to make the description concise, possible combinations of various technical features in the above-mentioned embodiments are not all described. However, as long as there is no contradiction in the combination of these technical features, the combination of these technical features should be regarded as the scope of the present specification.

What described above are several embodiments of the present invention, and these embodiments are specific and in details, but not intended to limit the scope of the present invention. It should be understood by the skilled in the art that various modifications and improvements can be made without departing from the concept and the scope of the present invention. Therefore, the protection scope of the present invention is defined by the appended claims.

What is claimed is:

1. A gas sampling method for a fuel cell, comprising:
arranging a plurality of sampling pipelines and a plurality of sampling points, the plurality of sampling points being arranged at a cathode inlet, an anode outlet, an anode inlet, a cathode outlet, and in an anode flow channel, and a cathode flow channel of the fuel cell, the sampling points arranged in the anode flow channel and the cathode flow channel being located in central regions of cross sections of the flow channels, and the sampling pipelines being connected to the plurality of sampling points, respectively, and configured to guide gas inside the fuel cell out;
introducing reactant gases into the cathode inlet and the anode inlet, respectively, and connecting an electronic load between the anode plate and the cathode plate of the fuel cell; and
obtaining gas samples of the plurality of sampling points guided out by means of the sampling pipelines to complete gas sampling of the fuel cell.

2. The gas sampling method for the fuel cell of claim 1, wherein a step of arranging the plurality of sampling points specifically comprises:
arranging the plurality of sampling points in the anode flow channel of the fuel cell at identical intervals along a running direction of the anode flow channel; and
arranging the plurality of sampling points in the cathode flow channel of the fuel cell at identical intervals along a running direction of the cathode flow channel.

3. The gas sampling method for the fuel cell of claim 2, wherein the fuel cell comprises at least three anode flow channels and at least three cathode flow channels;
a step of arranging the plurality of sampling points specifically further comprises:
arranging the plurality of sampling points inside the anode flow channels spaced at intervals of one or more anode flow channels, and
arranging the plurality of sampling points inside the cathode flow channels spaced at intervals of one or more cathode flow channels.

4. The gas sampling method for the fuel cell of claim 1, wherein a step of arranging the plurality of sampling points specifically comprises:
dividing a plurality of first-type regions along a running direction of the anode flow channel inside the fuel cell, arranging the plurality of sampling points at a boundary of each first-type region, distribution densities of the sampling points in different first-type regions are not all identical; and
dividing a plurality of second-type regions along a running direction of the cathode flow channel inside the fuel cell, and distribution densities of the sampling points in different second-type regions are not all identical.

5. The gas sampling method for the fuel cell of claim 1, wherein before the introducing reactant gases into the cathode inlet and the anode inlet, respectively, and connecting an electronic load between the anode plate and the cathode plate of the fuel cell, the method further comprises:
introducing an inert gas into the sampling pipeline, and sweeping the plurality of sampling points and the sampling pipeline.

6. The gas sampling method for the fuel cell of claim 1, wherein before the obtaining the gas samples of the plurality of sampling points guided out by means of the sampling pipelines to complete gas sampling of the fuel cell, the method further comprises:
providing a sampling device;
introducing anode standard gas into the sampling pipelines, and analyzing, by the sampling device, first gas samples to obtain a first-type sampled result;
introducing cathode standard gas into the sampling pipelines, and analyzing, by the sampling device, second gas samples to obtain a second-type sampled result;
repeating above steps to obtain a plurality of first-type sampled results and a plurality of second-type sampled results;
analyzing the plurality of first-type sampled results and the plurality of second-type sampled results; obtaining a sampling correction coefficient of the sampling device through calculation; and
completing a calibration of the sampling device.

7. A gas sampling system for the fuel cell, comprising:
an anode plate provided with an anode flow channel supplying a passage for a gas flow;
a membrane electrode arranged on a side of the anode plate, the anode flow channel being disposed on the side of the anode plate;
a cathode plate arranged on a side of the membrane electrode, the side of the membrane electrode being away from the anode plate, and the cathode plate being provided with a cathode flow channel supplying a passage for a gas flow;
a plurality of sampling points arranged in the anode flow channel and the cathode flow channel and located in central regions of cross sections of the flow channels; and
a plurality of sampling pipelines connected to the plurality of sampling points, respectively, and configured to guide gas inside the fuel cell out.

8. The gas sampling system for the fuel cell of claim 7, wherein the plurality of sampling points are arranged in the anode flow channel of the fuel cell at identical intervals along a running direction of the anode flow channel, and arranged in the cathode flow channel of the fuel cell at identical intervals along a running direction of the cathode flow channel.

9. The gas sampling system for the fuel cell of claim 8, wherein the fuel cell comprises at least three anode flow channels and at least three cathode flow channels;
the plurality of sampling points are arranged inside the anode flow channels spaced at intervals of one or more anode flow channels, and arranged inside the cathode flow channels spaced at intervals of one or more cathode flow channels.

10. The gas sampling system for the fuel cell of claim 7, wherein the anode flow channel has a plurality of first-type regions along a running direction thereof; the cathode flow channel has a plurality of second-type regions along a running direction thereof; the plurality of sampling points are respectively disposed in the flow channel where a boundary of each first-type region is located, and in the flow channel where a boundary of each second-type region is located; and the distribution densities of the sampling points in different regions are not all identical.

11. A calibration method for an internal state model of a fuel cell, comprising:
determining an equivalent model for the fuel cell;
establishing an internal state process equation of the fuel cell by integrating the equivalent model for the fuel cell and working conditions of the fuel cell, and determining a quantity to be calibrated in the internal state process equation of the equivalent model for the fuel cell;
obtaining operational parameters in internal state process equation of the fuel cell by a multi-point gas sampling method for the fuel cell;
substituting the operational parameters into the internal state process equation of the equivalent model of the fuel cell to obtain one quantity or a set of quantities to be calibrated; and
performing step S03 and step S04 repeatedly to obtain a plurality of values of the quantity or a plurality of groups of values corresponding to the set of quantities to be calibrated, and completing a calibration of the quantities to be calibrated till a variation range of the quantity to be calibrated is within a preset range, or a sum of squared errors corresponding to the set of quantities to be calibrated is within the preset range.

12. The calibration method for the internal state model of the fuel cell of claim 11, specifically comprising:
the fuel cell being equivalent to a single-flow-channel and multiple-cavity model comprising at least a cathode inlet cavity and a cathode outlet cavity;
establishing the internal state process equation of the single-flow-channel and multi-cavity model by integrating a working current condition and a working voltage condition of a cathode cavity of the fuel cell, and the quality to be calibrated in the internal state process equation of the single-flow-channel and multi-cavity model being a flow resistance coefficient;
the operational parameters comprising a first operational parameter and a second operational parameter, obtaining a gas flow rate from the cathode inlet cavity into the cathode outlet cavity as the first operational parameter, and obtaining a discharged gas flow rate of the cathode outlet cavity as the second operational parameter;
substituting the first operational parameter and the second operational parameter into the internal state process equation of the single-flow-channel and multi-cavity model to obtain a flow resistance coefficient of the cathode of the fuel cell; and
performing step S031 and step S041 repeatedly to obtain a plurality of flow resistance coefficients, and completing the calibration of the flow resistance coefficient till a variation range of the quantity to be calibrated is within the preset range.

13. The calibration method for the internal state model of the fuel cell of claim 12, wherein:
the working current condition is iᵢₙA_{fc,in}+iₒᵤₜA_{fc,out}=I_{load}; A_{fc,in} denotes an active area of the inlet cavity of the fuel cell; A_{fc,out} denotes an active area of the outlet cavity of the fuel cell; I_{load} denotes a load current; iᵢₙ denotes a current density in the cathode inlet cavity; and iₒᵤₜ denotes a current density in the cathode outlet cavity;
the working voltage condition is:
$$\frac{R T}{{α}_{c} F} ln [ \frac{{s}_{stop} {i}_{in}}{( {s}_{stop} - {s}_{in} ) a {i}_{0}^{ref}} \times \frac{{C}_{ref}^{{O}_{2}}}{{C}_{ca , in}^{{O}_{2}} - \frac{{i}_{in}}{4 F} [ \frac{{L}_{{ }^{gdl}}}{{{D}_{{O}_{2}}^{eff} ( 1 - {s}_{in} )}^{2}} + \frac{1}{{h}_{{O}_{2}}} ]} ] - {i}_{in} {R}_{in} = \frac{R T}{{α}_{c} F} ln [ \frac{{s}_{stop} {i}_{out}}{( {s}_{stop} - {s}_{out} ) a {i}_{0}^{ref}} \times \frac{{C}_{ref}^{{O}_{2}}}{\begin{matrix}{C}_{ca , out}^{{O}_{2}} - \frac{{i}_{out}}{4 F} \\ [ \frac{{L}_{{ }^{gdl}}}{{{D}_{{O}_{2}}^{e f f} ( 1 - {s}_{out} )}^{2}} + \frac{1}{{h}_{{O}_{2}}} ]\end{matrix}} ] - {i}_{out} {R}_{out}$$
R denotes an ideal gas constant; F denotes a Faraday constant; T denotes an internal temperature of the fuel cell; L_{gdl} denotes a thickness of a gas diffusion layer; α_{c} denotes a reaction transfer coefficient of the cathode; sₛₜₒₚ denotes a liquid water saturation when the fuel cell stops working under an influence of flooding; sᵢₙ denotes a liquid water saturation at the cathode inlet; sₒᵤₜ denotes a liquid water saturation at the cathode outlet; a denotes a water activity; i₀^{ref} denotes a reference current density; h_{O}_{₂} denotes a convective mass transfer coefficient of oxygen; Rᵢₙ denotes ohmic resistance of the inlet cavity; Rₒᵤₜ denotes ohmic resistance of the outlet cavity; D_{O}_{₂}^{eff} denotes an effective diffusion coefficient of oxygen; C_{ref}^{O}^{₂} denotes a reference concentration of oxygen; C_{ca,in}^{O}^{₂} denotes an oxygen concentration in the cathode inlet cavity; C_{ca,out}^{O}^{₂} denotes an oxygen concentration in the cathode outlet cavity; iᵢₙ denotes a current density in the cathode inlet cavity; and iₒᵤₜ denotes a current density in the cathode outlet cavity.

14. The calibration method for the internal state model of the fuel cell of claim 12, wherein:
the internal state process equation of the single-flow-channel and multi-cavity model comprises a gas dynamic process model of the cathode inlet cavity and a gas dynamic process model of the cathode outlet cavity;
the gas dynamic process model of the cathode inlet cavity comprises:
$$\frac{d {p}_{ca , in}^{{N}_{2}}}{d t} = \frac{2 R {T}_{f c}}{{V}_{c a}} ( {W}_{air} ( 1 - {x}_{air , in}^{{O}_{2}} ) - {W}_{12} ( 1 - {x}_{ca , in}^{{O}_{2}} ) ) and$$
$$\frac{{dp}_{ca , in}^{{O}_{2}}}{d t} = \frac{2 R {T}_{f c}}{{V}_{c a}} ( {W}_{air} {x}_{sup}^{{O}_{2}} - {W}_{12} {x}_{ca , in}^{{O}_{2}} - \frac{{i}_{in}}{4 F} {A}_{fc , in} ) ; \frac{d {p}_{ca , in}^{{N}_{2}}}{d t}$$
denotes a pressure change rate of nitrogen in the cathode inlet cavity;
$$\frac{d {p}_{ca , in}^{{O}_{2}}}{d t}$$
denotes a pressure change rate of oxygen in the cathode inlet cavity; p_{ca,in}^{N}^{₂} denotes a pressure of the nitrogen in the cathode inlet cavity; p_{ca,out}^{O}^{₂} denotes a pressure of the oxygen in the cathode inlet cavity; C_{ca,in}^{O}^{₂} denotes the oxygen concentration in the cathode inlet cavity; R denotes an ideal gas constant; T_{fc} denotes an internal temperature of the fuel cell; V_{ca} denotes a volume of the cathode control body; Wₐᵢᵣ denotes an intake flow of dry air; x_{air,in}^{O}^{₂} denotes an oxygen volume fraction in the dry air at the inlet; W₁₂ denotes a gas flow rate from the cathode inlet cavity into the cathode outlet cavity; x_{ca,in}^{O}^{₂} denotes an oxygen partial pressure at the cathode inlet; xₛᵤₚ^{O}^{₂} denotes a set oxygen partial pressure in gas supplied to the cathode inlet; iᵢₙ denotes a current density in the cathode inlet cavity; and A_{fc,in} denotes an active area of the cathode inlet cavity;
the gas dynamic process model of the cathode outlet cavity comprises:
$$\frac{d {p}_{ca , out}^{{N}_{2}}}{d t} = \frac{2 R {T}_{f c}}{{V}_{c a}} ( {W}_{12} ( 1 - {x}_{ca , in}^{{O}_{2}} ) - {W}_{r m} ( 1 - {x}_{ca , out}^{{O}_{2}} ) ) and$$
$$\frac{d {p}_{ca , out}^{{O}_{2}}}{d t} = \frac{2 R {T}_{f c}}{{V}_{c a}} ( {W}_{12} {x}_{ca , in}^{{O}_{2}} - {W}_{r m} {x}_{ca , out}^{{O}_{2}} - \frac{{i}_{out}}{4 F} {A}_{fc , out} ) ;$$
wherein
$$\frac{d {p}_{ca , out}^{{N}_{2}}}{d t}$$
denotes a pressure change rate of nitrogen in the cathode outlet cavity;
$$\frac{d {p}_{ca , out}^{{O}_{2}}}{d t}$$
denotes a pressure change rate of oxygen in the cathode outlet cavity; p_{ca,out}^{N}^{₂} denotes a pressure of the nitrogen in the cathode outlet cavity; p_{ca,out}^{O}^{₂} denotes a pressure of the oxygen in the cathode outlet cavity; C_{ca,out}^{O}^{₂} denotes an oxygen concentration in the cathode outlet cavity; x_{ca,in}^{O}^{₂} denotes an oxygen partial pressure at the cathode inlet; x_{ca,out}^{O}^{₂} denotes an oxygen partial pressure in the cathode outlet cavity; iₒᵤₜ denotes a current density in the cathode outlet; A_{fc,out} denotes an active area of the cathode outlet cavity; Wᵣₘ denotes a discharged gas flow rate at a rear of the cathode;
$${W}_{12} = 2 {k}_{c a} ( {p}_{ca , in} - {p}_{ca , out} ) \frac{{p}_{ca , in} - {p}_{s a t}}{R {T}_{f c}} ;$$
$${W}_{rm} = 2 {k}_{c a} ( {p}_{ca , out} - {p}_{rm} ) \frac{{p}_{ca , out} - {p}_{s a t}}{R {T}_{f c}} ; {k}_{ca}$$
denotes a flow resistance coefficient of the cathode cavity of the fuel cell and is a quantity be calibrated in the internal state process equation of the equivalent model for the fuel cell; p_{ca,in} denotes a gas pressure in the cathode inlet cavity; p_{ca,out} denotes a gas pressure in the cathode outlet cavity; pₛₐₜ denotes a saturated water vapor pressure; and Wᵣₘ denotes a discharged gas flow rate at a rear.

15. The calibration method for the internal state model of the fuel cell of claim 11, specifically comprising:
the fuel cell being equivalent to a model of difference between flow channels comprising a plurality of flow channels;
establishing a cathode discharged gas flow model by combining a gravity-direction linear distribution relationship of a liquid water saturation in an exhaust pipe of the fuel cell, the cathode discharged gas flow model being the internal state process equation of the model of difference between the flow channels, and the quantities to be calibrated in the cathode discharged gas flow model is a data set composed of a linear parameter and a reference quantity.
the operational parameters comprising a third operational parameter, a fourth operational parameter, and a fifth operational parameter, obtaining a gas pressure at each flow channel inlet of the cathode as the third operational parameter, obtaining a gas pressure at each flow channel outlet of the cathode as the fourth operational parameter, and obtaining a distance between an initial flow channel and each flow channel as the fifth operational parameter;
substituting the third operational parameter, the fourth operational parameter, and the fifth operational parameter into the cathode discharged gas flow rate model to obtain a data set;
performing step S032 and step S042 repeatedly to obtain a plurality of data sets, and completing the calibrations of the linear parameter and the reference quantity till a sum of squared errors corresponding to the linear parameter and the reference quantity is within a preset range, respectively.

16. The calibration method for the internal state model of the fuel cell of claim 15, wherein the cathode discharged gas flow model is:
$${W}_{ca , out} = \frac{{p}_{ca , in} - {p}_{ca , out}}{{k}_{1} + {k}_{2} ( 1 + \frac{{ρ}_{1}}{{ρ}_{g}} s ) {μ}_{g}} ;$$
wnerein W_{ca,out} denotes a gas flow rate at each flow channel outlet of the cathode; p_{ca,in} denotes a gas pressure at each flow channel inlet of the cathode; p_{ca,out} denotes a gas pressure at each flow channel outlet of the cathode; k₁ denotes an orifice flow rate coefficient of the flow channel; k₂ denotes an orifice flow coefficient of an exhaust manifold pipe; ρ₁ denotes a density of liquid water; ρ_{g} denotes a density of discharged gas; μ_{g} denotes a gas viscosity; s denotes a liquid water saturation of each flow channel; assuming that the liquid water saturation of each flow channel is linearly distributed and satisfies s=kx+b, wherein x denotes the distance between the initial flow channel and each flow channel; k denotes a linear parameter; and b denotes a reference quantity.

17. The calibration method for the internal state model of the fuel cell of claim 16, wherein:
calculating the gas flow rate W_{ca,out}^{model} at each flow channel outlet of the cathode by estimating different values of the linear parameter and the reference quantity, and by changing the gas pressure p_{ca,in} at each flow channel inlet of the cathode and the distance x between the initial flow channel and each flow channel; and
substituting the calculated gas flow rate W_{ca,out}^{model} at each flow channel outlet of the cathode and a really measured gas flow rate W_{ca,out}^{real} at each flow channel outlet of the cathode into an equation r²=Σ(W_{ca,out}^{real}−W_{ca,out}^{model})², calculating a sum r² of squared errors corresponding to each set of data, and a linear parameter and a reference quantity being correspondingly determined as an optimal solution when the sum r² of the squared errors is less than 0.001, and completing the calibration.

18. A computer equipment, comprising a memory, a processor, and computer programs stored in the memory, wherein the computer programs, when executed by the processor, cause the processer to perform steps of claim 11.

19. A computer readable storage medium, comprising computer programs stored thereon, wherein the computer programs, when executed by a processer, cause the processor to perform steps of claim 11.
